(19) United States
(12) Patent Application Publication
(10) Pub. No.: US 2011/0076603 A1
(43) Pub. Date: Mar. 31, 2011

(54) ORGANIC PHOTORECEPTOR, IMAGE FORMING APPARATUS AND PROCESS CARTRIDGE

(75) Inventors: Toyoko SHIBATA, Zama-shi (JP); Tomoko SAKIMURA, Tokyo (JP); Shinichi HAMAGUCHI, Tokyo (JP); Masanori YUMITA, Tokyo (JP)

(73) Assignee: KONICA MINOLTA BUSINESS TECHNOLOGIES, INC., Tokyo (JP)

(21) Appl. No.: 12/891,502

(22) Filed: Sep. 27, 2010

(30) Foreign Application Priority Data
Sep. 30, 2009 (JP) 2009-226744

(51) Int. Cl. G03G 15/00; G03G 21/18

(52) U.S. Cl. 430/56; 399/111; 399/159; 430/58.75; 430/132

(57) ABSTRACT

An object of the invention is to provide an image forming apparatus and process cartridge both employing the organic photoreceptor by improving an abrasion resistance of the organic photoreceptor up to the same level as an amorphous silicone photoreceptor, the image blur and image flow problem liable to generate in high temperature and high moisture condition, and to provide an organic photoreceptor capable of obtaining a precise and a high quality dot image by short wavelength laser exposure. Provided is an organic photoreceptor having a conductive substrate, provided thereon at least a photo receiving layer and a protective layer in this order, wherein the protective layer comprises at least a resin layer obtained by a reaction between a chain polymerizable compound having a charge transportable structure represented by Formula (1) and a chain polymerizable compound without having a charge transportable structure.

This application is based on Japanese Patent Application No. 2009-226744 filed on Sep. 30, 2009 with Japan Patent Office, the entire content of which is hereby incorporated by reference.

### TECHNICAL HELD

The present invention relates to an organic photoreceptor used for an electrophotographic image forming apparatus and so forth, and to an image forming apparatus fitted with the organic photoreceptor and a process cartridge thereof.

### BACKGROUND

The present invention can provide an organic photoreceptor and an image forming apparatus exhibiting a halftone image without uneven density in long-term usage in an image forming apparatus to repeatedly conduct image formation, comprising an organic photoreceptor and provided thereabout, at least a charging member, an exposure member, a developing member and a transferring member.

It has been demanded to reduce a diameter of photoreceptor due to downsizing of the image forming apparatus as well as speeding up and maintenance-free, so as to improve the durability of the photoreceptor. From these standpoints, organic photoreceptor is generally soft due to having low molecular charge transport material and inert polymer as main component of surface layer, and has disadvantage to be liable to abrasion by mechanical load of developing system or cleaning system when it is repeatedly used in the electro photographic process. Further, hardness of rubber for cleaning blade and contact pressure is forced to increase, for the purpose of increasing cleaning property of the miniaturization of the toner particles for attaining high image quality. This also causes to accelerate the abrasion of the photoreceptor. This abrasion of the photoreceptor results in deterioration of electrical properties such as lowering sensitivity or lowering charging and cause of irregular image such as lowering image density and image stain. Abrasion line locally generated on the photoreceptor results in insufficient cleaning and image with stripe scumming. In fact, this abrasion or abrasion line limits the life of photoreceptor, resulting in replacement thereof.

In order to improve durability of the photoreceptor, it is indispensable to reduce above wear amount. Further, it is necessary to obtain the organic photoreceptor having good surface, so as to achieve excellent cleaning property and transferring property. These are the problems most pressured to be solved in this field.

The technology for improving abrasion resistance of the photosensitive layer includes: (1) technology utilizing curable binder in the surface layer (Patent Document 1), (2) technology utilizing polymer type charge transport material (Patent Document 2), and (3) technology utilizing the surface layer having inorganic filler dispersion (Patent Document 3). Among them, technology utilizing curable binder in the surface layer as (1) tends to increase residual potential by impurity such as polymerization initiator or un-reacted residual group due to poor miscibility with charge transport material, resulting in lowering of image density. Technology utilizing polymer type charge transport material as (2) and technology utilizing the surface layer having inorganic filler dispersion as (3) can improve abrasion resistance to some extent, but abrasion resistance required to the organic photoreceptor can not be accomplished sufficiently. Further, technology utilizing the surface layer having inorganic filler dispersion as (3) tends to increase residual potential by trap existing on the surface of inorganic filler, resulting in lowering of image density. Thus, by these technologies as (1), (2) and (3), total resistance required to the organic photoreceptor including electrical resistance and mechanical resistance can not be accomplished sufficiently.

Further, so as to improve abrasion resistance and scratch resistance in (1), disclosed is a photoreceptor including multi-functional cure type acrylate monomer (Patent Document 4). However, as for the photoreceptor, there is no specific description, while only described is that the multi-functional cure type acrylate monomer may be included in the protective layer provided on photosensitive layer and that charge transport material may be included in the protective layer. Moreover, when low molecular charge transport material is included in the protective layer, problem of miscibility with cured material described above may occur, resulting in precipitation of low molecular charge transport material, generation of crack, and lowering mechanical strength. Described is that polycarbonate resin is included so as to improve miscibility, but due to decreasing content of curable acryl monomer, consequently abrasion resistance cannot be accomplished sufficiently. Further, in the case of photoreceptor without having charge transport material in the surface layer, even though described is that surface layer is formed as thin layer due to decreasing exposed portion potential, the life of the photoreceptor becomes shorter due to thin layer thickness. Further, due to poor ambient stability of charging potential or exposed portion potential, these values varies with an effect of an ambient temperature and humidity, and cannot be accomplished to hold sufficient value.

With respect to an abrasion resistance technology of the photosensitive layer in place of above, disclosed is a technology in which charge transport layer is formed by using coating liquid comprising monomer having carbon-carbon double bond, charge transport material having carbon-carbon double bond and binder resin (Patent Document 5). This binder resin includes binder resin formed by monomer having carbon-carbon double bond and charge transport material having carbon-carbon double bond, and binder resin without having above double bond and without having reactivity. Even though this photoreceptor attracts in terms of balancing between abrasion resistance and good electric properties, in case of using non-reactive compound as binder resin, it is liable to occur imperfect cleaning because poor miscibility between binder resin and cured compound formed by reaction of above monomer and charge transport material results in phase separation and uneven surface during curing step. Further, in above case, binder resin inhibits curing of monomer. As above monomer used in this photoreceptor, bi-functional monomer is specifically described. Sufficient cross-linking density cannot be obtained by this bi-functional monomer due to being small number of functional group, and abrasion resistance can not be accomplished sufficiently. Further, in the case of using binder having reactivity, it is difficult to balance between bonding amount of charge transport material and cross-linking density due to being small number of functional group in above monomer and above binder resin, and abrasion resistance and good electric properties can not be accomplished sufficiently.

Further, disclosed is a photosensitive layer containing cured compound of hole transport compound having two or more chain polymerizable functional groups in the same molecule (Patent Document 6). However, as this photoreceptor has bulky hole transport compound having two or more chain polymerizable functional groups, resistance cannot be accomplished sufficiently such that strain occurs in cured compound and result in occurring roughness of surface layer or crack because of higher inner stress along with time. Further, there is no disclosure about curing method in which solvent amount is controlled before polymerization. Therefore, layer density may not be increased enough and abrasion resistance may not be accomplished sufficiently. Moreover, close cross-linked layer cannot be realized due to lower layer density, resulting in unstable properties according to an ambient change such as oxidizing gas or humidity and afterimage appears as an irregular image under actual using environment. Thus, stable image output in long term cannot be realized.

Further, disclosed is cross-linked type charge transport layer in which tri- or more functional radical polymerization monomer without having charge transport structure and mono-functional radical polymerization compound having charge transport structure is cured (Patent Document 7). By using mono-functional radical polymerization compound having charge transport structure, crack of photosensitive layer is inhibited as well as mechanical and electrical resistivity. However, according to an ambient change such as oxidizing gas or humidity, property become unstable and afterimage appears as an irregular image under actual using environment. Thus, stable image output in long term cannot be realized.

Recently, organic photoreceptor is developed using a laser of short wavelength as an exposure light source for forming precise digital image. Besides above problems, conventional organic photoreceptor developed for a long wavelength laser exposure has poor sensitivity, when conducting image exposure employing short wavelength laser light as by narrowing a light exposure dot diameter, and problem occur such that a latent image cannot be clearly formed and reproducibility of dot image is liable to be deteriorated.
Patent Document 1: Unexamined Japanese Patent Application (hereinafter, refers to as JP-A) No. 56-48637
Patent Document 2: JP-A No. 64-1728
Patent Document 3: JP-A No. 4-281461
Patent Document 4: Examined Japanese Patent Application Publication No. 3262488
Patent Document 5: Examined Japanese Patent Application Publication No. 3194392
Patent Document 6: JP-A No. 2000-66425
Patent Document 7: JP-A No. 2004-302450

### SUMMARY

The object of this invention is to dissolve the above mentioned problems, so as to improve an abrasion resistance of the organic photoreceptor up to the same level as an amorphous silicone photoreceptor, to improve the image blur and image flow problem liable to generate in high temperature and high moisture condition, and to provide an organic photoreceptor capable of obtaining a precise and a high quality dot image by short wavelength laser exposure. The other object is to provide an image forming apparatus and process cartridge both employing the organic photoreceptor.

The above object has been attained by the following constitutions:

1. An organic photoreceptor having a conductive substrate, provided thereon at least a photo sensitive layer and a protective layer in this order, wherein the protective layer comprises a resin layer obtained by a reaction between a chain polymerizable compound having a charge transportable structure represented by Formula (1) and a chain polymerizable compound without having a charge transportable structure,

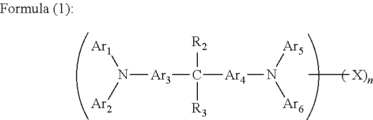

wherein R₂ and R₃ each represents alkyl group or aryl group, R₂ and R₃ may be joined to form a ring structure; Ar₃ and Ar₄ each represents substituted or un-substituted arylene group; Ar₁, Ar₂, Ar₅ and Ar₆ each represents substituted or un-substituted aryl group; n is an integer of 1 to 4 and represents a number of a substituted hydrogen atom in Ar₁, Ar₂, Ar₅ and Ar₆ by X, wherein X is a group represented by Formula (2),

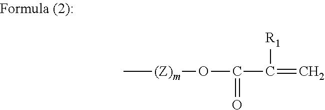

wherein R₁ represents hydrogen atom, halogen atom, substituted or un-substituted alkyl group, substituted or un-substituted aralkyl group, substituted or un-substituted aryl group, cyano group, nitro group, alkoxy group, —COOR₄ (R₄ represents hydrogen atom, substituted or un-substituted alkyl group, substituted or un-substituted aralkyl group, or substituted or un-substituted aryl group), halogenated carbonyl group or CONR₅R₆ (R₅ and R₆ each represents hydrogen atom, halogen atom, substituted or un-substituted alkyl group, substituted or un-substituted aralkyl group, or substituted or un-substituted aryl group and may be the same or different), Z represents substituted or un-substituted alkylene group, substituted or un-substituted alkylene ether divalent group, alkylene oxy carbonyl divalent group; and m is an integer of 0 to 3.
2. The organic photoreceptor of item 1, wherein the chain polymerizable compound having a charge transportable structure represented by Formula (1) is represented by Formula (3),

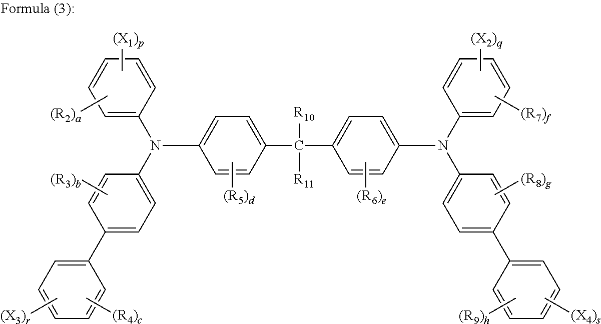

wherein R₂ to R₉ each represents alkyl group or alkoxy group having 1 to 5 carbon numbers; a to h represents an integer of 0 to 5; R₁₀ and R₁₁ each represents alkyl group or aryl group and R₁₀ and R₁₁ may be joined to form a ring structure; X₁, X₂, X₃ and X₄ each represents Formula (2); p, q, r and s each represents an integer of 0 or 1 respectively and at least one of p, q, r and s represents an integer of 1.
3. The organic photoreceptor of item 1 or 2, wherein R₁ in Formula (2) is hydrogen atom, substituted or un-substituted alkyl group.
4. The organic photoreceptor of any one of items 1 to 3, wherein a number of the chain polymerizable functional group in the chain polymerizable compound without having the charge transportable structure is 3 or more.
5. The organic photoreceptor of any one of items 1 to 4, wherein the protective layer comprises metal oxide particles.
6. An image forming apparatus to repeatedly conduct image formation, comprising an organic photoreceptor and provided thereabout, at least a charging member, an exposing member, and a developing member, wherein the organic photoreceptor is the organic photoreceptor of any one of items 1 to 5.
7. A process cartridge utilized in the image forming apparatus of item 6, comprising at least one of the organic photoreceptor of any one of items 1 to 5, the charging member, the exposing member and the developing member integrated as a unit which can be adopted to be installed to or released from the image forming apparatus.
8. A method for producing an organic photoreceptor having a conductive substrate, provided thereon at least a photo sensitive layer and a protective layer in this order, so as to form the protective layer, comprising a step of reacting a chain polymerizable compound having a charge transportable structure represented by Formula (1) with a chain polymerizable compound without having a charge transportable structure,

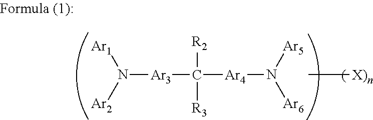

wherein R₂ and R₃ each represents alkyl group or aryl group, R₂ and R₃ may be joined to form a ring structure; Ar₃ and Ar₄ each represents substituted or un-substituted arylene group; Ar₁, Ar₂, Ar₅ and Ar₆ each represents substituted or un-substituted aryl group; n is an integer of 1 to 4 and represents a number of a substituted hydrogen atom in Ar₁, Ar₂, Ar₅ and Ar₆ by X, wherein X is a group represented by Formula (2),

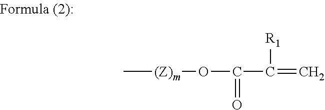

wherein R₁ represents hydrogen atom, halogen atom, substituted or un-substituted alkyl group, substituted or un-substituted aralkyl group, substituted or un-substituted aryl group, cyano group, nitro group, alkoxy group, —COOR₄ (R₄ represents hydrogen atom, substituted or un-substituted alkyl group, substituted or un-substituted aralkyl group, or substituted or un-substituted aryl group), halogenated carbonyl group or CONR₅R₆ (R₅ and R₆ each represents hydrogen atom, halogen atom, substituted or un-substituted alkyl group, substituted or un-substituted aralkyl group, or substituted or un-substituted aryl group and may be the same or different), Z represents substituted or un-substituted alkylene group, substituted or un-substituted alkylene ether divalent group, alkylene oxy carbonyl divalent group; and m is an integer of 0 to 3.

The organic photoreceptor of the present invention remarkably improves the potential property at repeatedly image forming, resistance of abrasion or rubbing on the surface of the organic photoreceptor, the scratch line resistance or wear amount on surface of photoreceptor, the image blur problem in high temperature and high moisture condition, and provides an organic photoreceptor capable of obtaining a precise and a high quality dot image by short wavelength laser exposure.

### BRIEF DESCRIPTION OF THE DRAWINGS

FIG. 1 is a schematic view showing incorporation of functions of the image forming apparatus of the present invention.

FIG. 2 is a sectional constitution view of a color image forming apparatus showing an embodiment of the present invention.

FIG. 3 is a sectional constitution view of a color image forming apparatus utilizing an organic photoreceptor of the present invention.

### DESCRIPTION OF THE PREFERRED EMBODIMENTS

The organic photoreceptor of the present invention is characterized by having a conductive substrate, provided thereon at least a photosensitive layer and a protective layer in this order, wherein the protective layer comprises at least a resin layer obtained by a reaction between a chain polymerizable compound having a charge transportable structure represented by Formula (1) and a chain polymerizable compound without having a charge transportable structure.

By comprising above constitution, the organic photoreceptor of the present invention can remarkably improve the potential property at repeatedly image forming, resistance of abrasion or rubbing on the surface of the organic photoreceptor, the scratch line resistance or wear amount on surface of photoreceptor, the image blur problem in high temperature and high moisture condition, and provide an organic photoreceptor capable of obtaining a precise and a high quality dot image by short wavelength laser exposure.

A polymer forming reaction is divided broadly into a chain polymerization and a sequential polymerization. The chain polymerization of the chain polymerizable compound according to the present invention means former pattern of polymerization reaction. Specifically, for example, as disclosed in Miwa Tadahiro, “Kiso Goseijushi no kagaku (new edition)”, Gihoudou shuppan, Jul. 25, 1995 (1^{st} print, 8^{th} edition), it is unsaturated polymerization, ring-opening polymerization and isomerized polymerization in which the reaction proceeds mainly via intermediate such as radical or ion.

A chain polymerizable compound is a compound which has unsaturated polymerizable functional group, ring-opening polymerizable functional group or isomerized polymerizable functional group which proceeds forsaid chain polymerization reaction.

As the chain polymerizable compound related to the present invention, specifically preferred is a compound having unsaturated polymerizable functional group which proceeds radical reaction.

A cured resin layer related to the present invention is a resin layer formed by reaction proceeding of the chain polymerizable compound and so forth.

A chain polymerizable compound related to the present invention having charge transportable structure represented by Formula (1) will now specifically be described.

Specific example represented by Formula (1) includes:

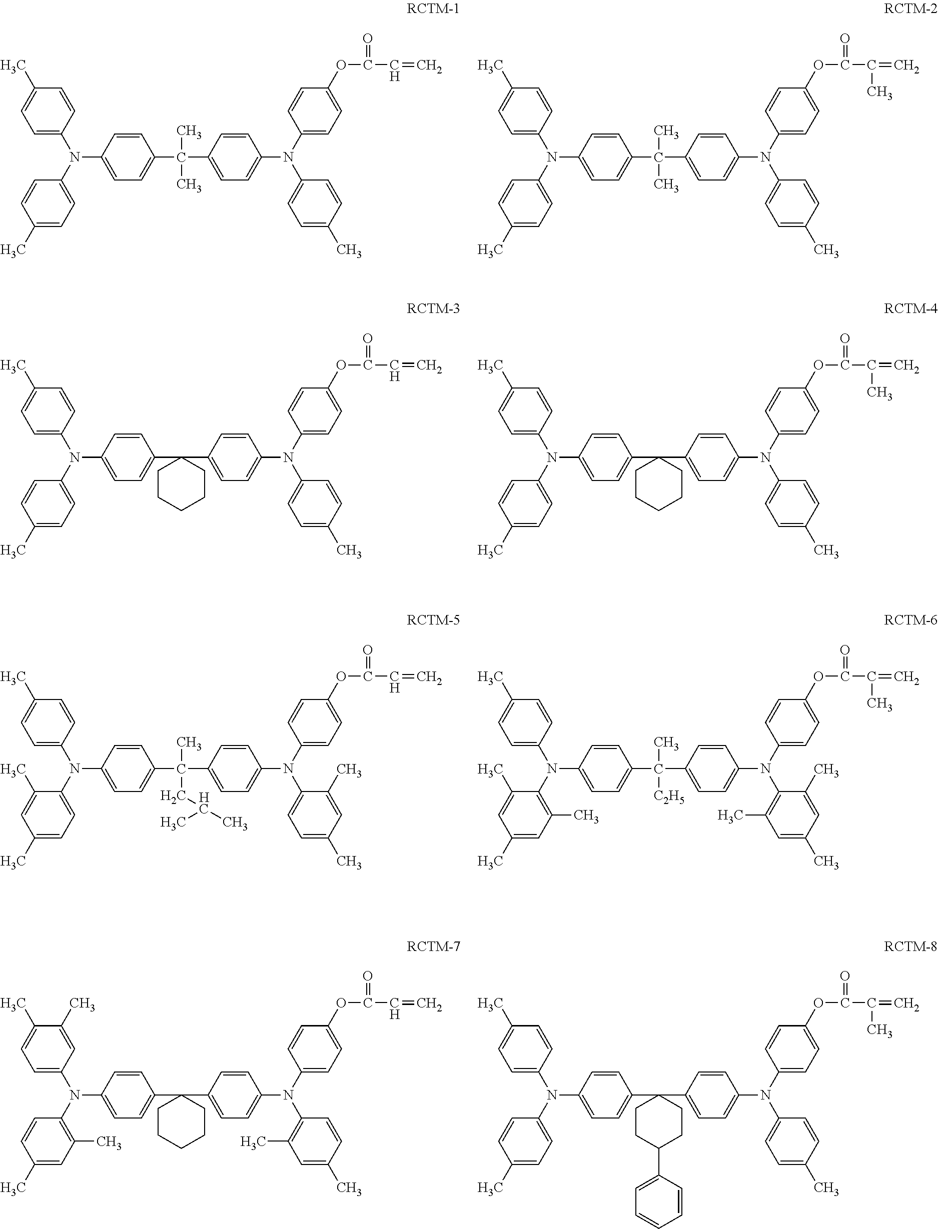

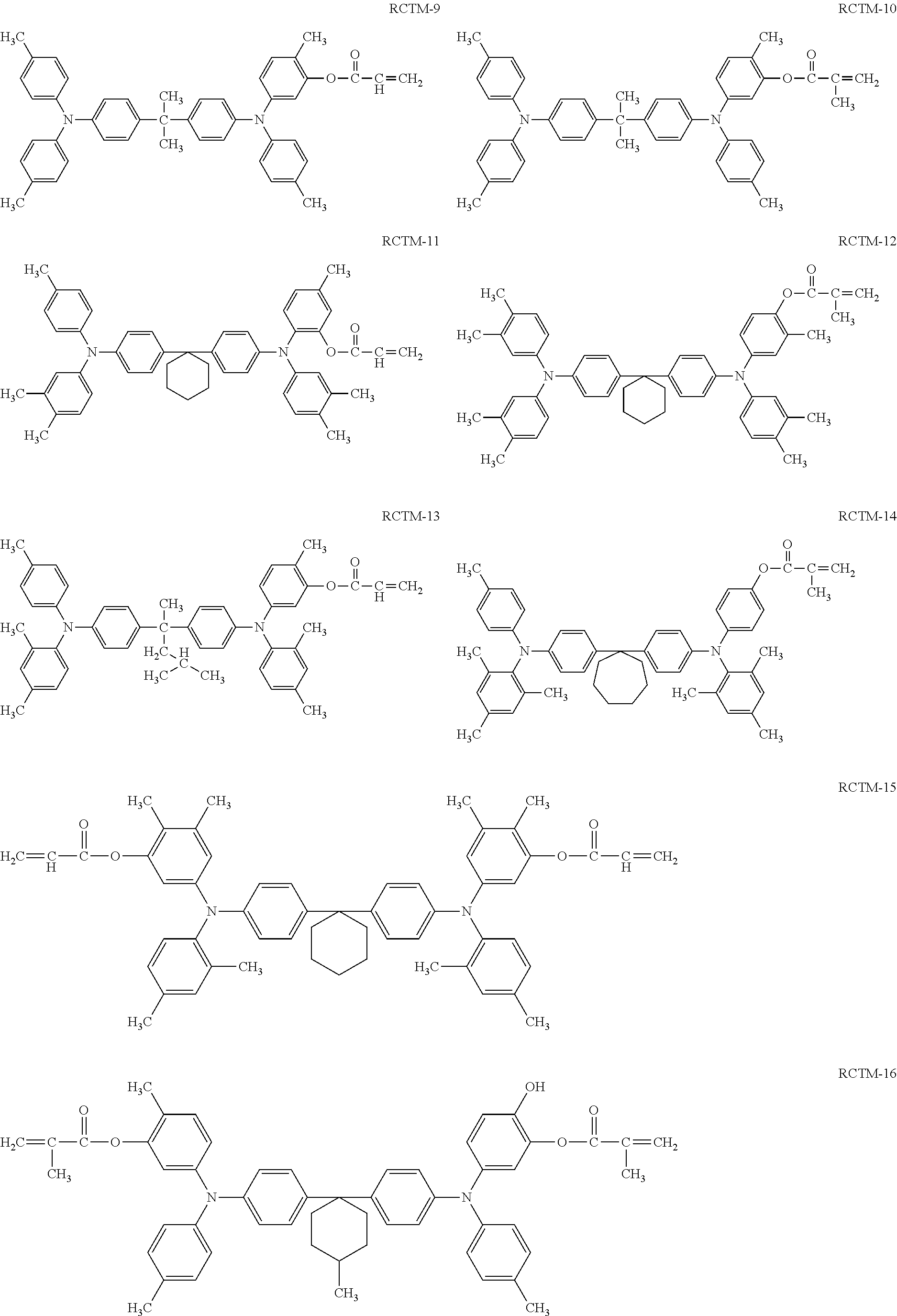

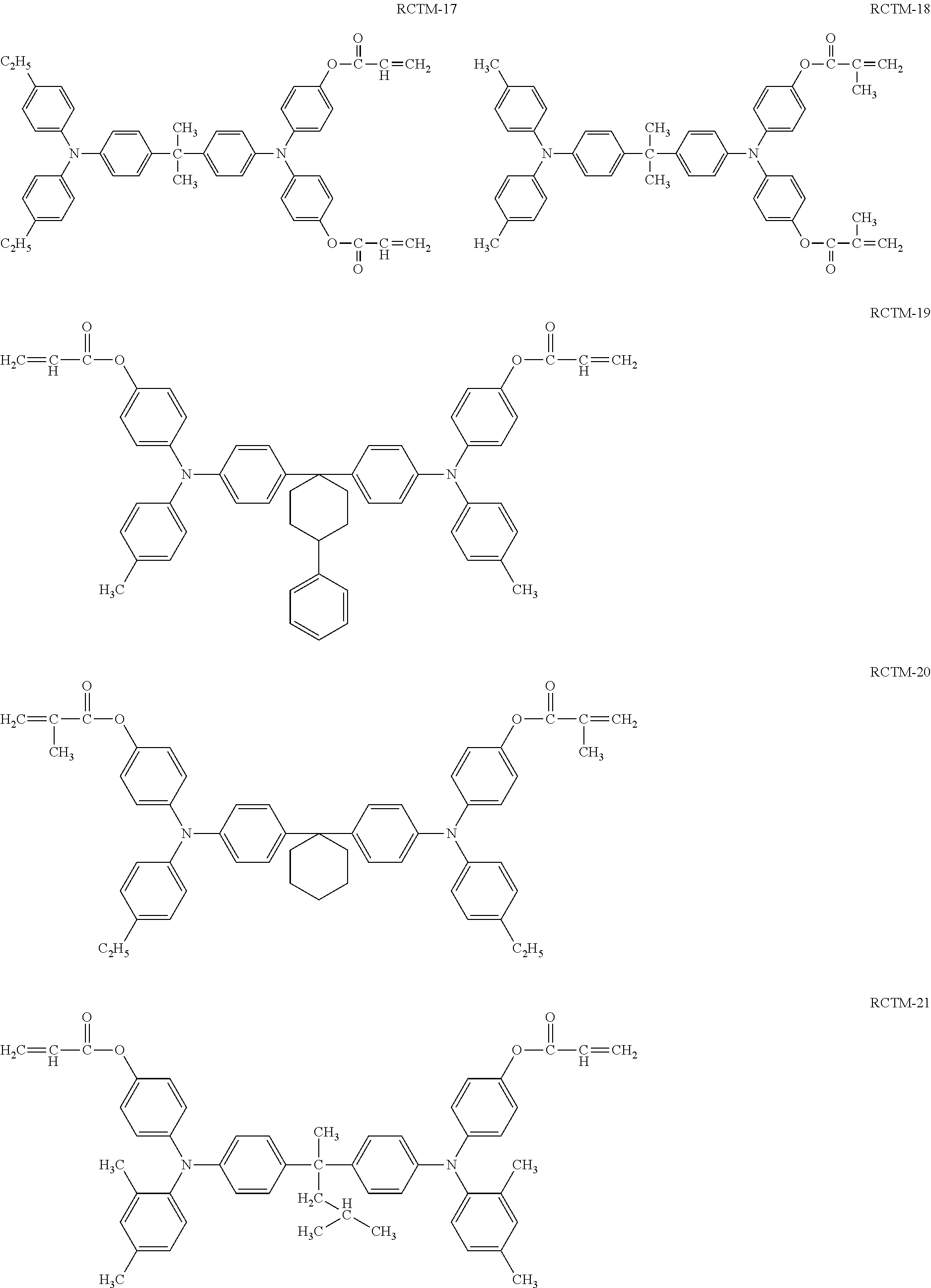

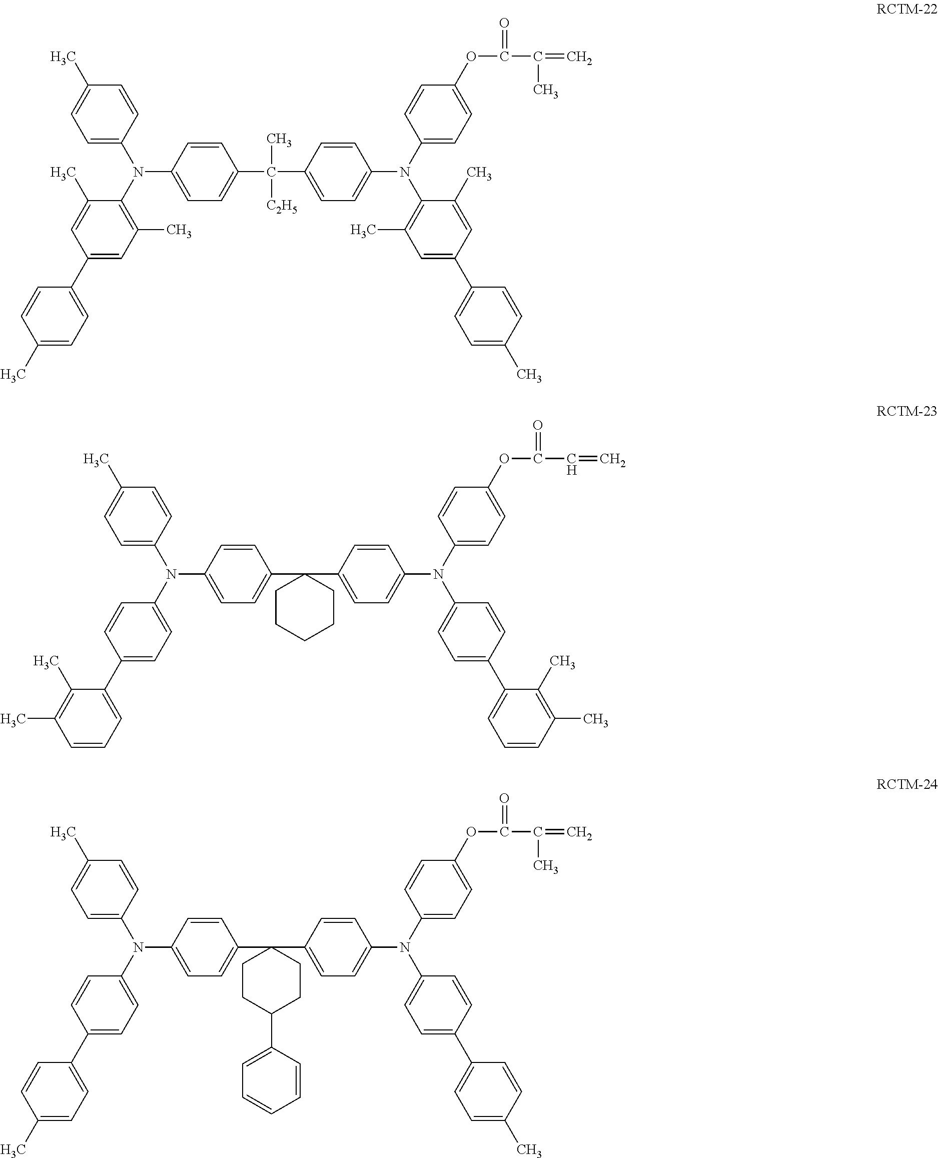

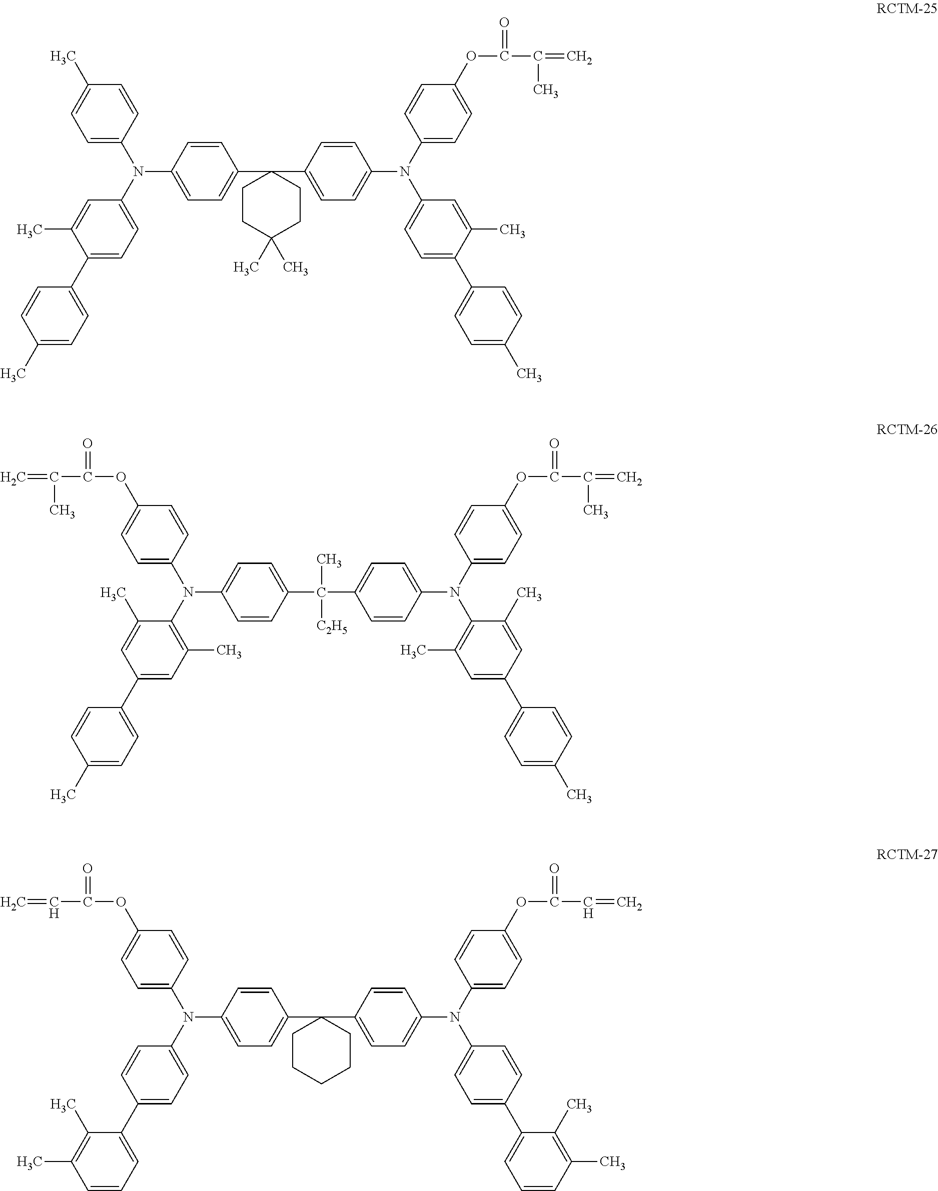

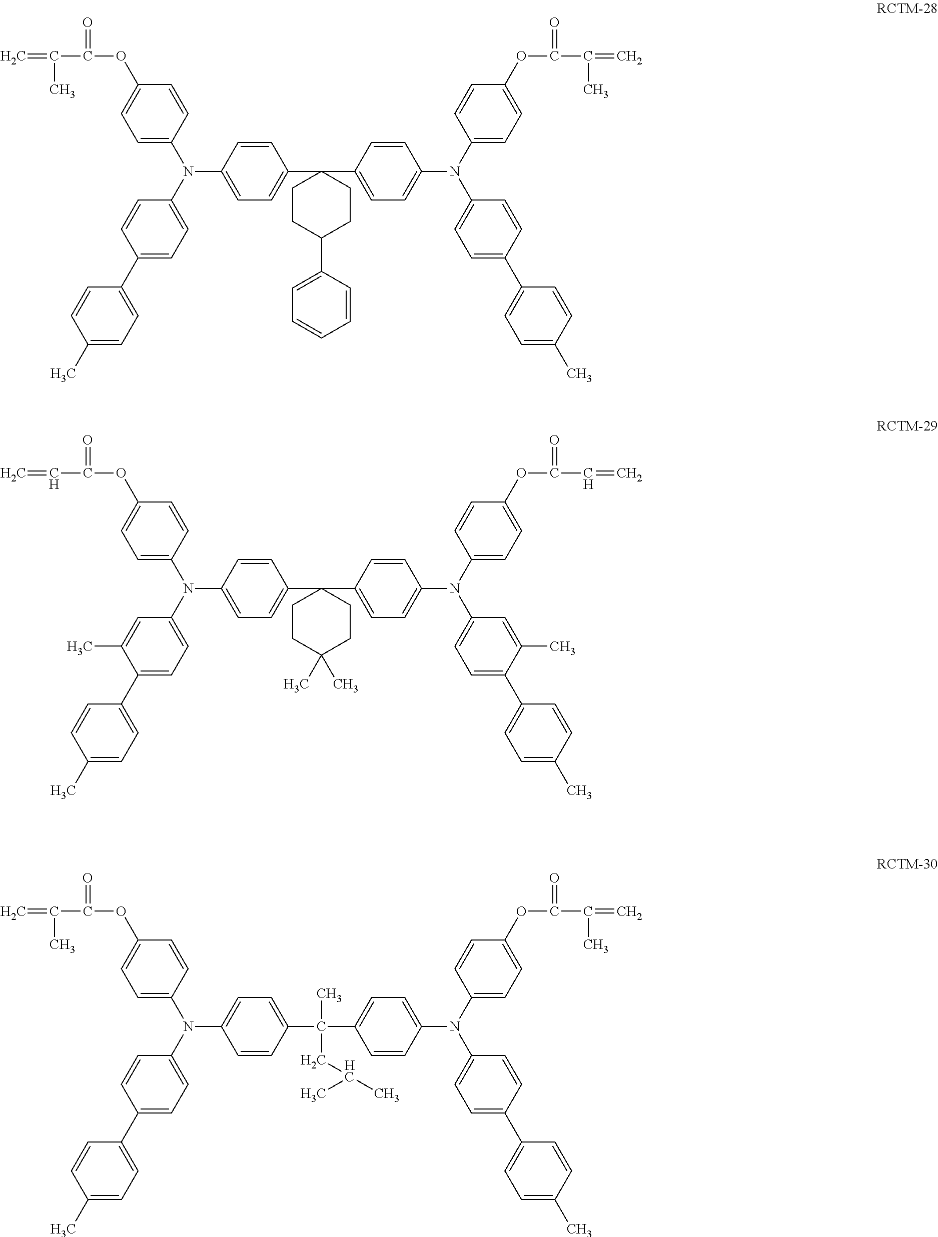

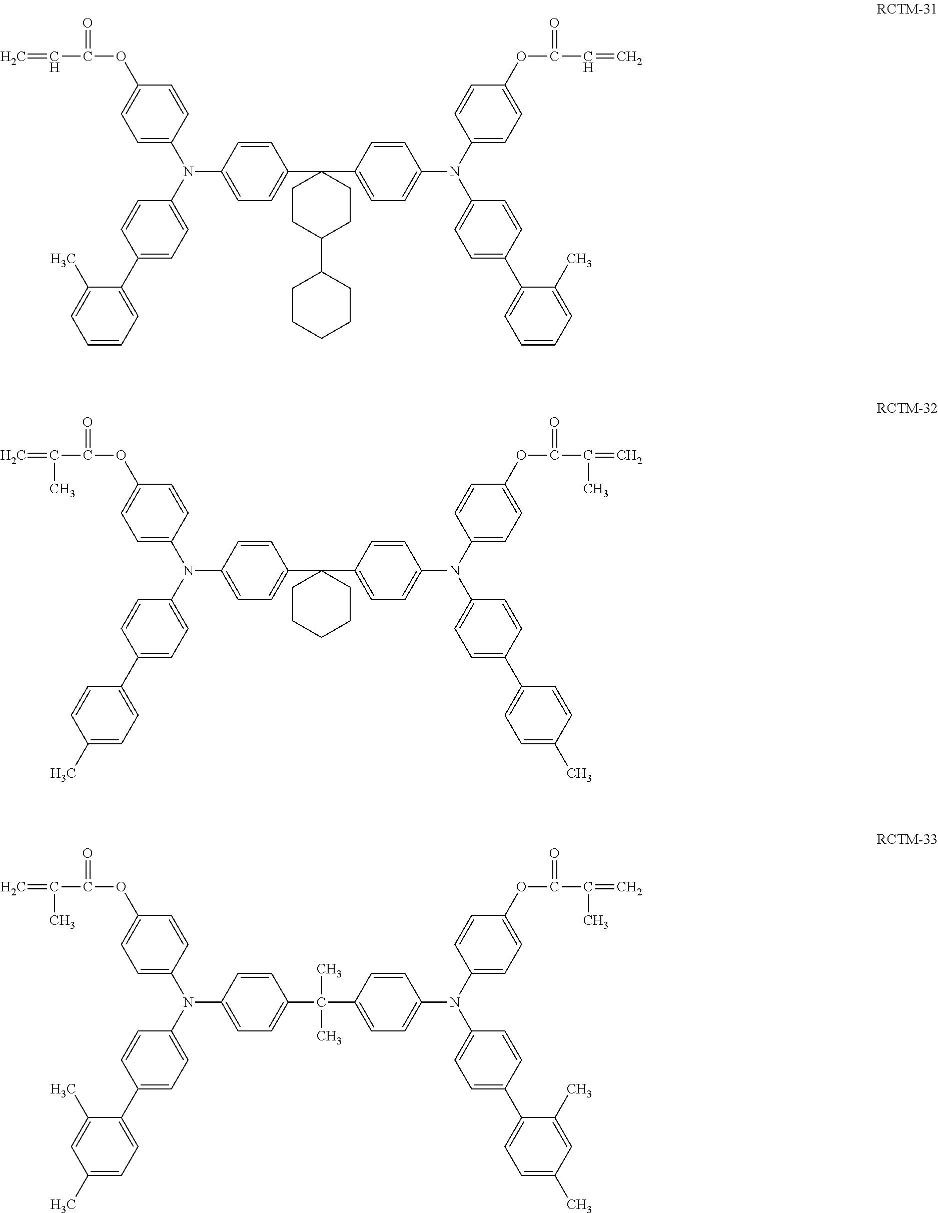

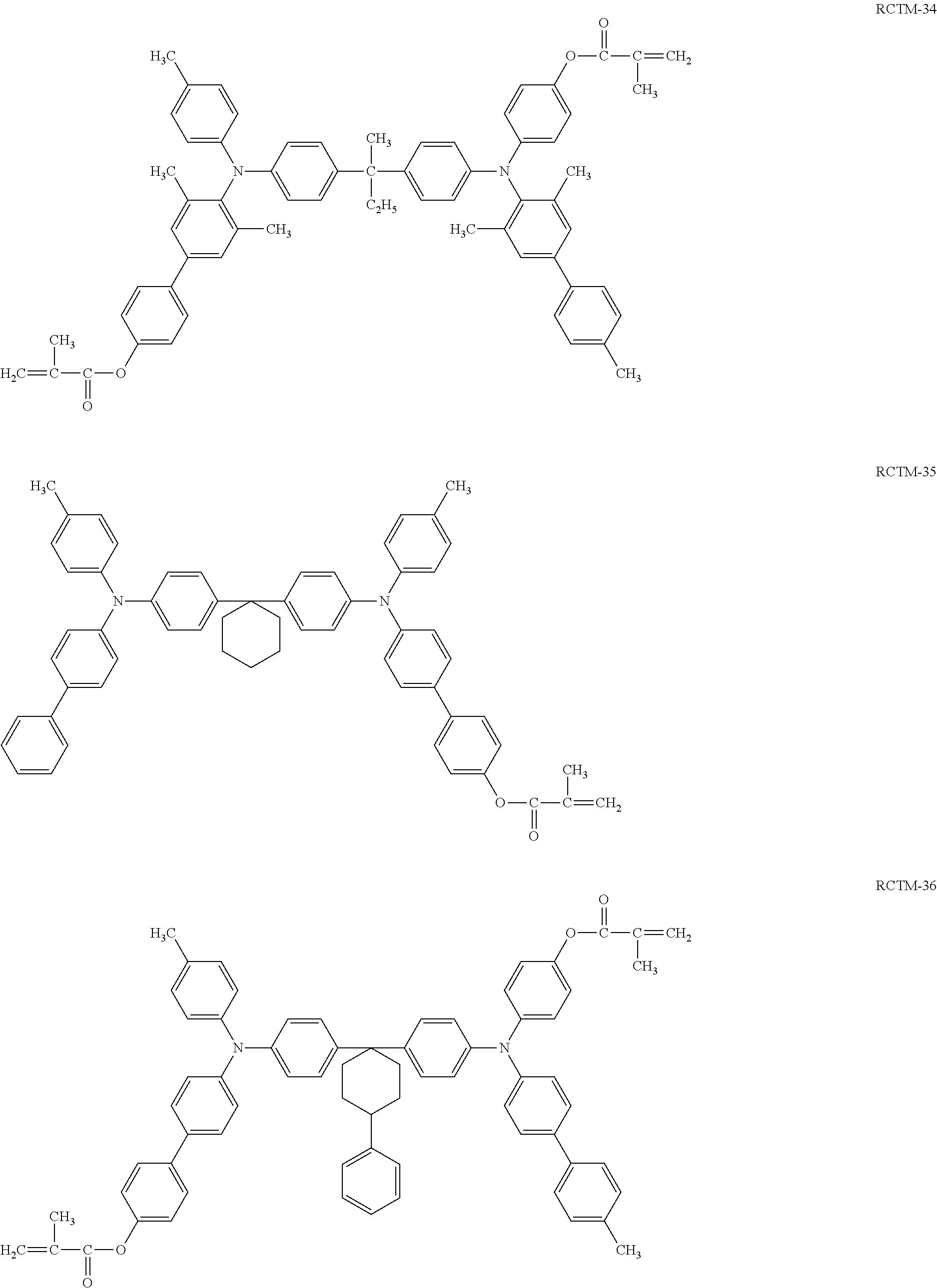

### Synthesis Example of Compound Represented by Formula (1)

### Synthesis Example 1

### Synthesis of RCTM-2

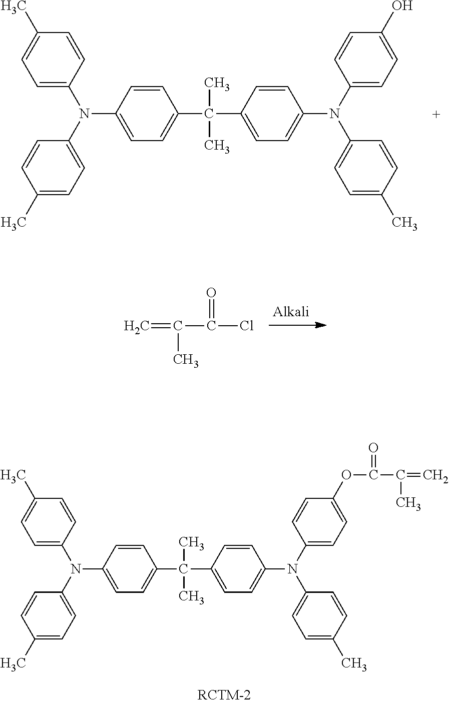

Into a 4-necked flask were introduced 30 g of hydroxyl body represented in above reaction formula, 150 ml of dioxane, 10 g of 20% aqueous solution of sodium hydroxide. Into the flask, 5.2 g of methacryloyl chloride was dropping while stirring and keeping inner temperature at 10° C. or less by cooling 5° C. or less. After the dropping, the solution was reacted 2 hours, 500 ml of water was added and extracted by 300 ml of toluene. After the resultant solution was washed by water to neutralize, dehydrated, concentrated and purified by silica gel column, monomer of synthesis example RCTM-2 was obtained.

### Synthesis Example 2

### Synthesis of RCTM-3

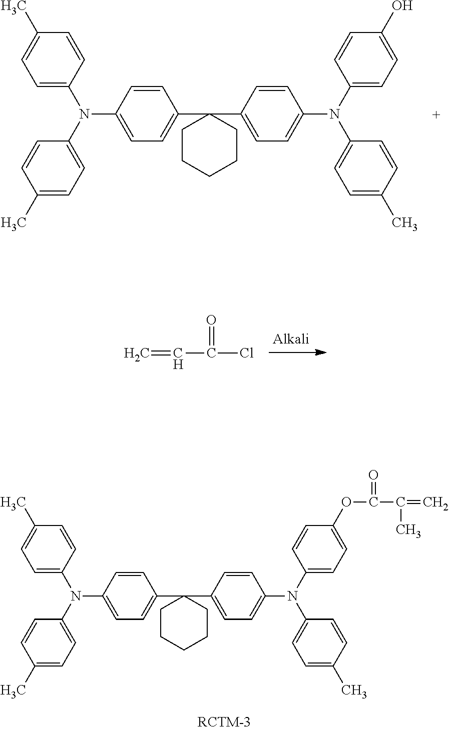

Into a 4-necked flask were introduced 30 g of hydroxyl body represented in above reaction formula, 150 ml of dioxane, 10 g of 20% aqueous solution of sodium hydroxide. Into the flask, 5.9 g of acryloyl chloride was dropping while stirring and keeping inner temperature at 10° C. or less by cooling 5° C. or less. After the dropping, the solution was reacted 2 hours, 500 ml of water was added and extracted by 300 ml of toluene. After the resultant solution was washed by water to neutralize, dehydrated, concentrated and purified by silica gel column, monomer of synthesis example RCTM-3 was obtained.

### Synthesis Example 3

### Synthesis of RCTM-32

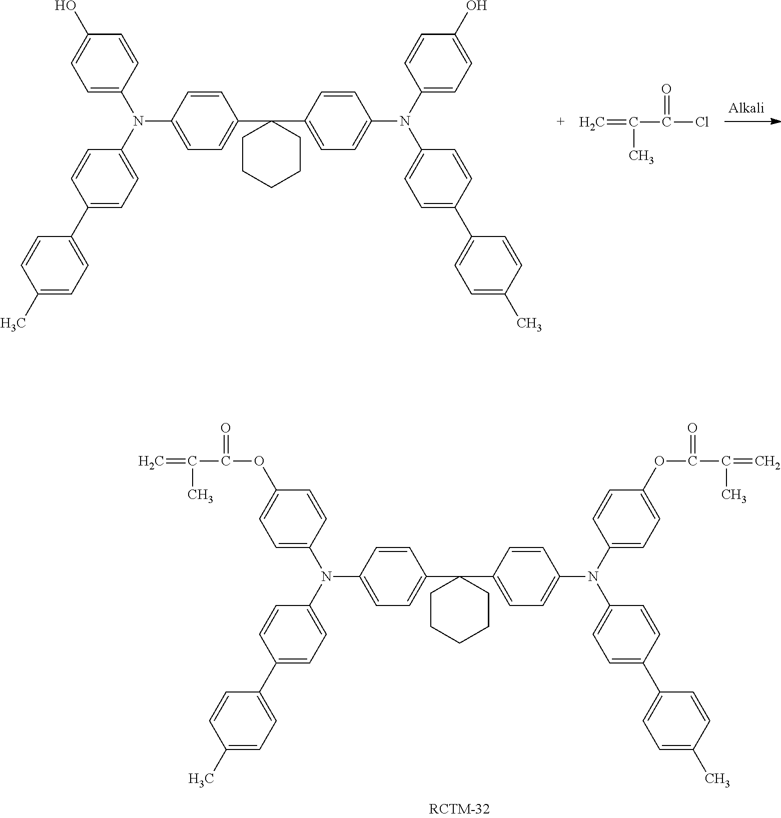

Into a 4-necked flask were introduced 30 g of hydroxyl body represented in above reaction formula, 150 ml of dioxane, 10 g of 20% aqueous solution of sodium hydroxide. Into the flask, 8.8 g of methacryloyl chloride was dropping while stirring and keeping inner temperature at 10° C. or less by cooling 5° C. or less. After the dropping, the solution was reacted 2 hours, 500 ml of water was added and extracted by 300 ml of toluene. After the resultant solution was washed by water to neutralize, dehydrated, concentrated and purified by silica gel column, monomer of synthesis example RCTM-32 was obtained.

A chain polymerizable compound without having a charge transportable structure related to the present invention will now specifically be described.

The chain polymerizable compound without having a charge transportable structure is a general chain polymerizable compound and means lower molecular compound which can form a resin employable as a binder resin of photoreceptor such as polystyrene or poly acrylate by polymerizing (curing) via irradiation of actinic radiation such as ultraviolet ray or electron beam. Particularly preferred examples include styrene monomers, acrylic monomers, methacrylic monomers, vinyl toluene monomers, vinyl acetate monomers, and N-vinyl pyrrolidone monomes.

Of these, a particularly preferred example is the chain polymerizable compound including an acryloyl group (CH₂═CHCO—) or methacryloyl group (CH₂═CCH₃CO—), because this compound can be cured by a small amount of light or in a shorter period of time.

In the present invention, these chain polymerizable compounds without having a charge transportable structure can be used independently or in a mixed form.

As for cationic chain polymerizable compound without having a charge transportable structure, specifically epoxy compound, vinyl ether compound and oxcetane compound is included. Of these, oxcetane compound is preferred.

The following shows examples of the chain polymerizable compounds without having a charge transportable structure:

| Exemplified | | |
|---|---|---|
| compound No. | Structural formula | Ac group number |
| 1 | 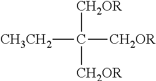 | 3 |
| 2 | 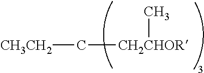 | 3 |
| 3 | 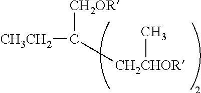 | 3 |
| 4 | 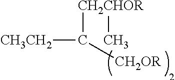 | 3 |
| 5 | 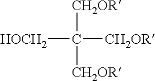 | 3 |
| 6 | 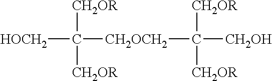 | 4 |
| 7 | 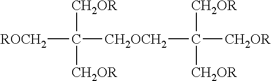 | 6 |
| 8 | 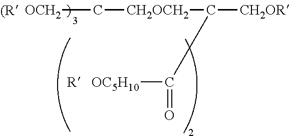 | 6 |
| 9 | 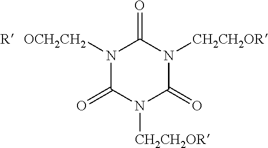 | 3 |
| 10 | 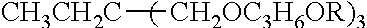 | 3 |
| 11 | 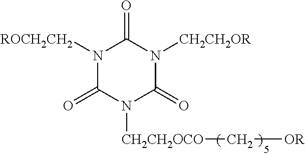 | 3 |
| 12 | 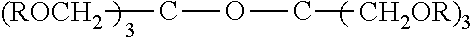 | 6 |
| 13 | 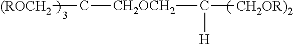 | 5 |
| 14 | 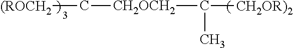 | 5 |
| 15 | 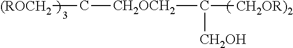 | 5 |
| 16 | 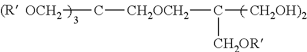 | 4 |
| 17 | 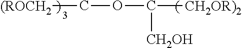 | 5 |
| 18 | 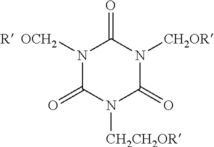 | 3 |
| 19 | 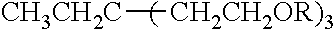 | 3 |
| 20 | 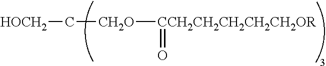 | 3 |
| 21 | 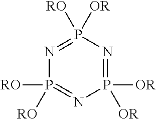 | 6 |
| 22 | 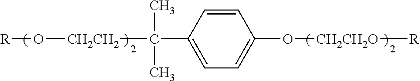 | 2 |
| 23 | 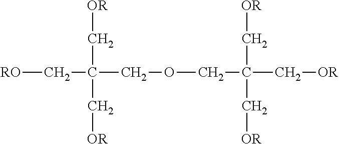 | 6 |
| 24 | 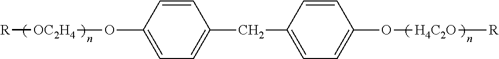 | 2 |
| | (n ≈ 2) | |
| 25 | 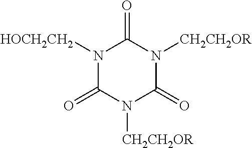 | 2 |
| 26 | 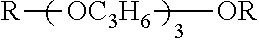 | 2 |
| 27 | 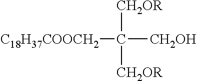 | 2 |
| 28 | 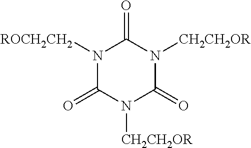 | 3 |
| 29 | 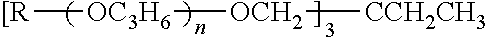 | 3 |
| | (n ≈ 3) | |
| 30 | 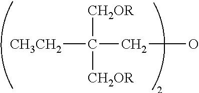 | 4 |
| 31 | 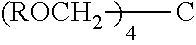 | 4 |
| 32 | RO—C₆H₁₂—OR | 2 |
| 33 | 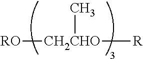 | 2 |
| 34 | 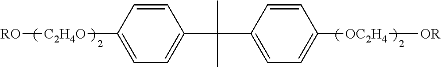 | 2 |
| 35 | 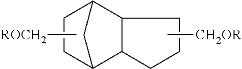 | 2 |
| 36 | 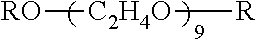 | 2 |
| 37 | 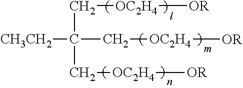 | 3 |
| | (l + m + n = 3) | |
| 38 | 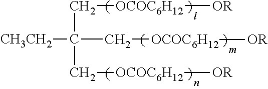 | 3 |
| | (l + m + n = 3) | |
| 39 | Mixture of | |
| | 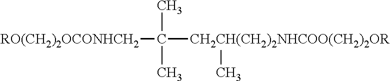 | |
| | and | |
| | 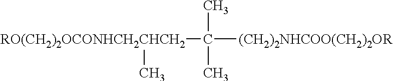 | |
| 40 | (ROCH₂)₃CCH₂OCONH(CH₂)₆NHCOOCH₂C(CH₂OR)₃ | |
| 41 | 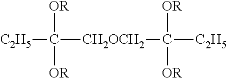 | |
| 42 | 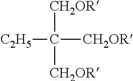 | |
| 43 | 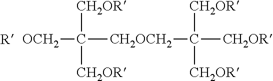 | |
| 44 | 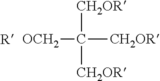 | |

It should be noted that R and R′ in the above description will be shown in the following:

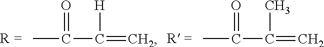

Specific examples of preferable oxcetane compound is described below, but compounds usable in the invention are not limited thereof.

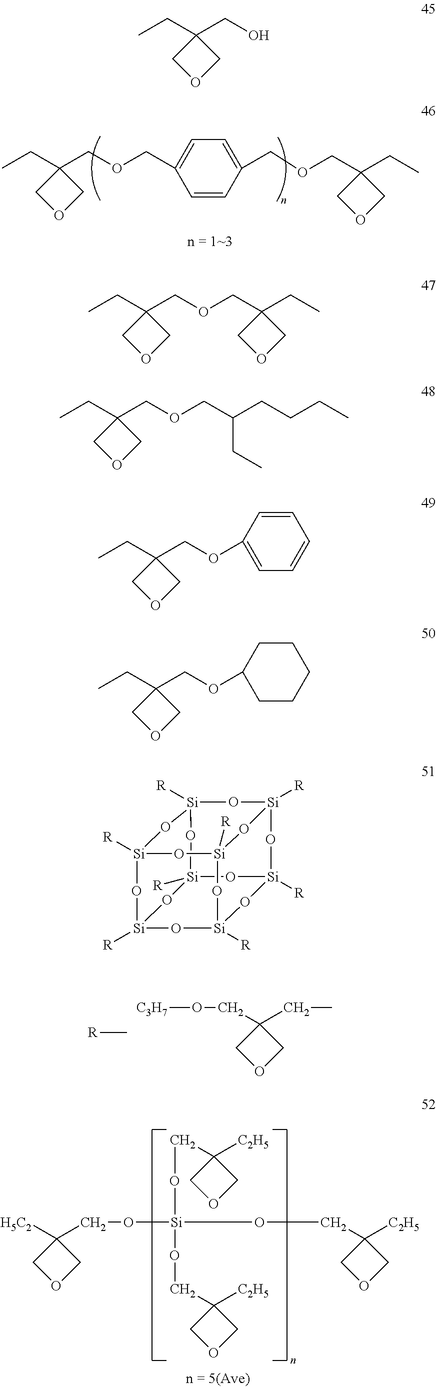

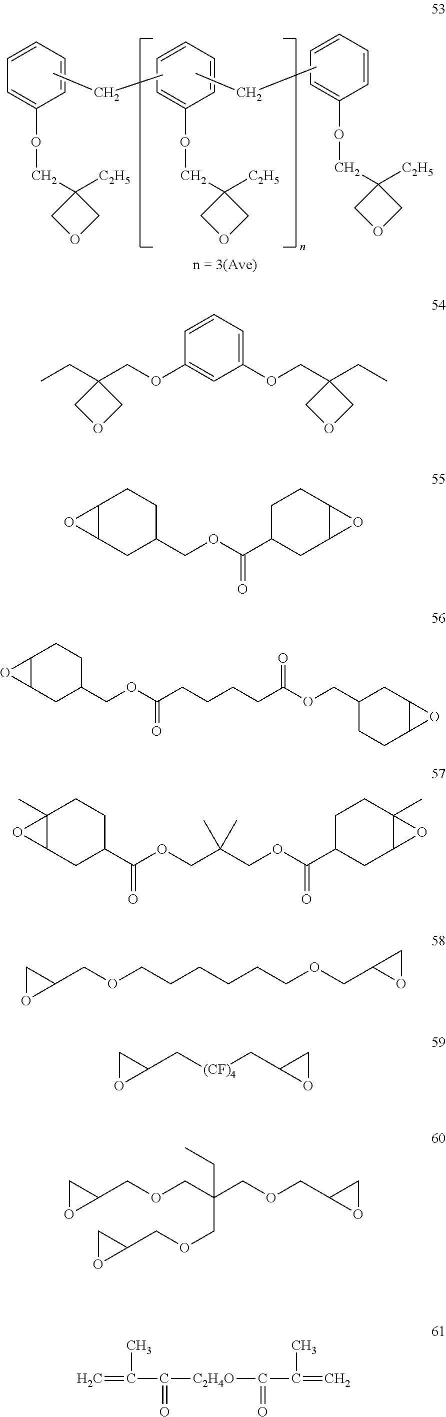

Epoxy compound include aromatic epoxide, alicyclic epoxide and aliphatic epoxide.

In the invention, a number of functional group in the chain polymerizable compound without having a charge transportable structure is preferable 3 or more. Further, the chain polymerizable compound without having a charge transportable structure may be employed in combinations of at least two types. In this case, content of the chain polymerizable compound without having a charge transportable structure having a number of functional group being 3 or more is preferable 50% or more by mass.

The curable resin layer in the protective layer may be formed by reacting a chain polymerizable compound (A) having a charge transportable structure represented by Formula (1) and a chain polymerizable compound (B) without having a charge transportable structure. As a ratio of (B) to (A) in the component, 1 to 1,000 parts by mass of (B) is preferable based on 100 parts by mass of (A), more preferable 50 to 150 parts by mass of (B).

In a reaction of the chain polymerizable compound having a charge transportable structure represented by Formula (1) and a chain polymerizable compound without having a charge transportable structure, a method reacting initiated electron beam cleavage, or a method reacting by light or heat via adding radical polymerization initiator or cation polymerization initiator are employed. A light polymerization initiator or a heat polymerization initiator may be employed. The light and heat polymerization initiators are employed in combination.

Light polymerization initiator is preferable for the radical polymerization initiator of the photo curable compounds. Alkyl phenone type compounds and phosphine oxide type compounds are preferable among them. Compounds having an α-hydroxy acetophenone structure or an acylphosphine oxide structure are particularly preferable. Ion type polymerization initiators composed of aromatic onium compound of diazonium, ammonium, iodonium, sulfonium, and phosphonium of B(C₆F₅)₄⁻, PF₆⁻, AsF₆⁻, SbF₆⁻ and CF₃SO₃⁻, or nonion type polymerization initiators such as sulfone compound generating sulfonic acid, halogen compounds generating hydrogen halides, or iron arene complex compounds to initiate cation polymerization. Particularly the nonion type initiators of the sulfone compound generating sulfonic acid and the halogen compounds generating hydrogen halides are preferable.

Compound examples of the photopolymerization initiators used preferably in the present invention will now be listed.

### Examples of α-Aminoacetophenone Type Compounds:

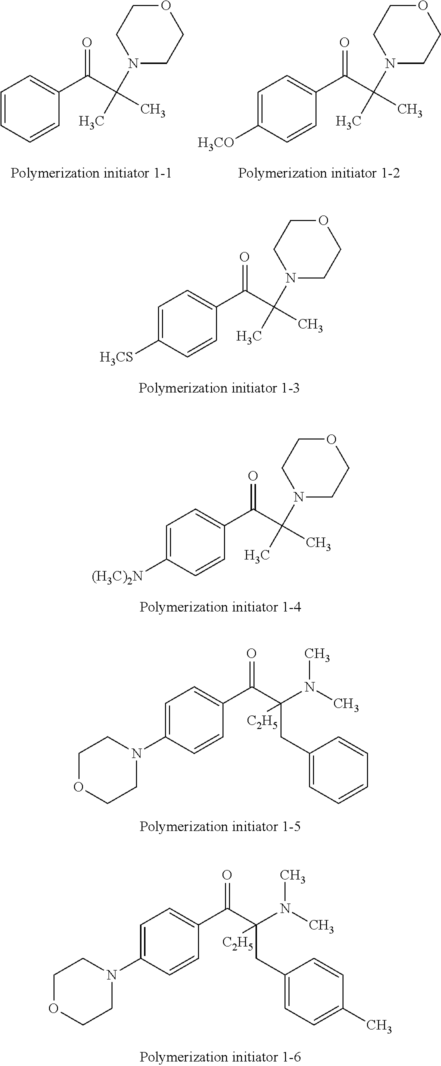

### Examples of α-Hydroxy Acetophenone Type Compounds:

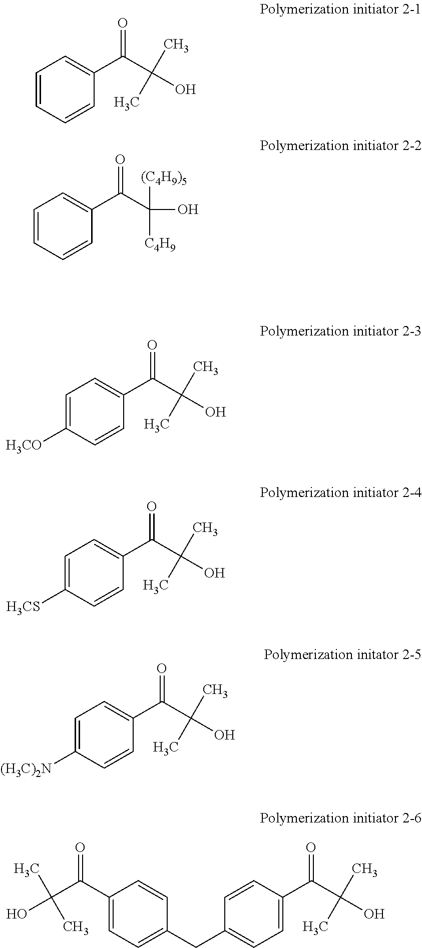

### Examples of Aeylphosphine Oxide Type Compounds:

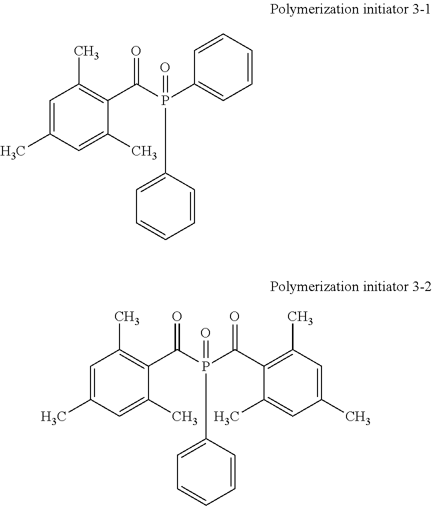

### Examples of Other Radical Type Polymerization Initiator:

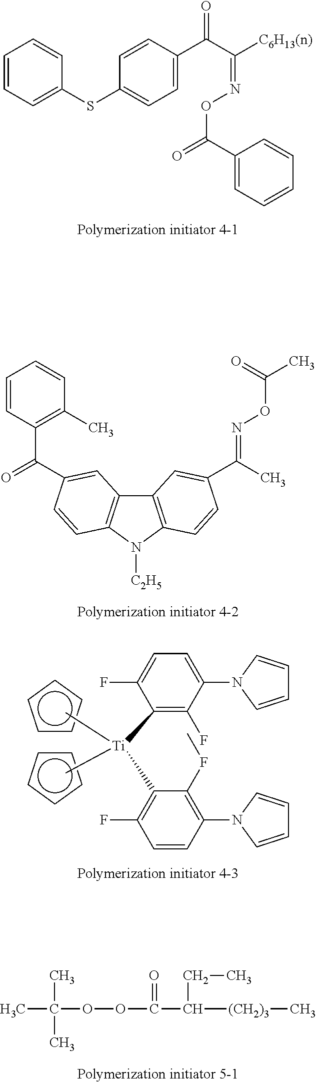

### Examples of Nonion Type Polymerization Initiator:

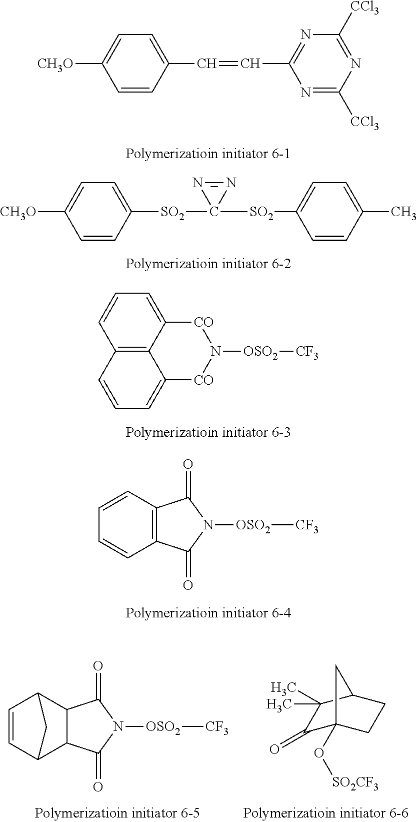

### Examples of Ionic Type Polymerization Initiator:

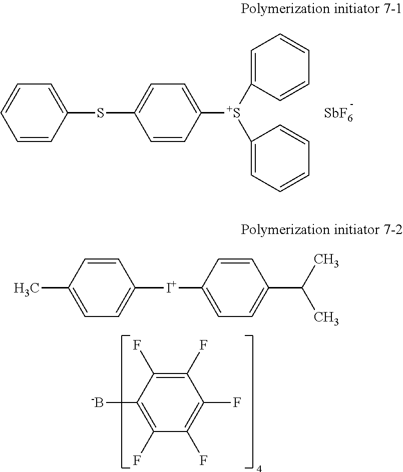

To form a protective layer of photo curable resin, a production method is preferably used wherein a protective layer coating liquid (composition including metal oxide surface-treated by chain polymerizable compound) is coated on a photosensitive layer, and then primary drying is carried out to the extent that the coated film exhibits no fluidity, followed by curing of the protective layer via ultraviolet ray irradiation to carry out secondary drying to adjust the amount of volatile substances in the coated film to be a specified amount.

As an apparatus for irradiating of ultraviolet ray, any appropriate apparatuses known in the art used for curing of ultraviolet ray curable resins are employable.

The amount (mJ/cm²) of ultraviolet ray radiation for use in ultraviolet ray curing of a resin is preferably controlled by ultraviolet ray irradiation intensity and irradiation duration.

As a heat polymerization initiator, ketone peroxide base compound, peroxyketal base compound, hydroperoxide base compound, dialkylperoxide base compound, diacylperoxide base compound, peroxydicarbonate base compound and peroxyester base compound is employed and these heat polymerization initiator are disclosed in manufactures product catalog and soforth.

According to the present invention, as well as above photo polymerization initiator, these heat polymerization initiators are mixed with metal oxide particles surface-treated by chain polymerizable compound, a chain polymerizable compound without having a charge transportable structure and a chain polymerizable compound having a charge transportable structure to prepare coating solution of protective layer. Then this coating solution is coated onto photosensitive layer and then dryed by heating, to form protective layer. As a heat polymerization initiator, radical polymerization initiator described above or other can be employable.

Further, with regard to a coating method of a protective layer, immersion coating, in which a photoreceptor is entirely immersed in a protective layer coating liquid, increases the diffusion of a polymerization initiator into an underlying layer. Therefore, to allow the film of a photosensitive layer under the protective layer to be dissolved as little as possible, it is preferable to use a coating process method such as amount regulation type (a typical example thereof is a circular slide hopper type) coating. The above circular amount regulation type coating is detailed, for example, in JP-A 58-189061.

These polymerization initiators each can be used independently or two or more of them can be used in combination. The content of the polymerization initiator is in the range of 0.1 through 20 parts by mass with respect to 100 parts by mass of acrylic compound, preferably in the range of 0.5 through 10 parts by mass.

The protective layer in the present invention can be further included of various charge transport materials, anti-oxidation agent and lubricant particles.

In order to enhance wear resistance of protective layer, addition of inorganic fine particles such as titanium oxide (TiO₂), zinc oxide (ZnO) and alumina in protective layer is preferred.

The number average primary particle diameter of inorganic fine particles is preferable in the range of 3.0 to 200 nm, most preferable in 5 to 100 nm. The number average primary particle diameter is determined using a scanning electron microscope (SEM) by enlarging at a magnification of 10,000. Then, Fere diameters in the horizontal direction with respect to 100 particles are calculated, and thereby the average value is designated as the number average primary particle diameter.

Resin particles containing fluorine atoms can be added to the protective layer in the present invention. The resin particles containing fluorine atoms are exemplified by ethylene tetrafluoride resin, ethylene trifluoride resin, ethylene hexafluoride propylene resin, vinyl fluoride resin, vinylidene fluoride resin, and ethylene difluoride dichloro resin. It is preferred that, of these copolymers, one or more should be adequately selected and used. Use of the ethylene tetrafluoride resin and vinylidene fluoride resin is particular preferred. The amount of the lubricant particles in the protective layer is in the range of 5 through 70 parts by mass, preferably in the range of 10 through 60 parts by mass, with respect to 100 parts by mass of the acrylic compound. The preferred particle size of the lubricant particles is such that the average primary particle size is 0.01 μm through 1 μm. The particularly preferred average primary particle size is 0.05 μm through 0.5 μm. There is no particular restriction to the molecular weight of the resin. A proper molecular weight of the resin can be selected.

The solvent for forming the protective layer is exemplified by methanol, ethanol, n-propyl alcohol, isopropyl alcohol, n-butanol, t-butanol, sec-butanol, benzyl alcohol, toluene, xylene, methylene chloride, methyl ethyl ketone, cyclohexane, ethyl acetate, butyl acetate, methyl cellosolve, ethyl cellosolve, tetrahydrofuran, 1-dioxane, 1,3-dioxolane, pyridine, and diethyl amine, without being restricted thereto.

It is preferably that the protective layer of the present invention is subjected to natural drying or heat drying after having been coated, then the protective layer is made to react by exposure to actinic radiation.

Similarly to the case of the intermediate layer or photosensitive layer, the protective layer can be coated according to such well-known methods as dip coating, spray coating, spinner coating, bead coating, blade coating, beam coating, and slide hopper coating methods.

For the photoreceptor of the present invention, the following step is preferably used: Actinic radiation is applied to a coating layer to generate radicals and cause polymerization. Intermolecular and intramolecular crosslinking is formed by a crosslinking reaction, and curing is performed to generate a cured resin. It is preferred in particular to use an ultraviolet ray and electron beam as actinic radiation.

There is no particular restriction to the ultraviolet light source if ultraviolet rays can be emitted. It is possible to use a low pressure mercury lamp, intermediate pressure mercury lamp, high pressure mercury lamp, extra-high pressure mercury lamp, carbon arc lamp, metal halide lamp, xenon lamp, flash or pulse xenon and others. Irradiation conditions differ according to each lamp. The dose of actinic radiation is normally in the range of 5 to 500 mJ/cm², preferably in the range of 5 through 100 mJ/cm². The electric power of the lamp is preferably in the range of 0.1 kW through 5 kW, more preferably in the range of 0.5 kW through 3 kW.

The electron beam irradiation apparatus as the electron beam source include, generally, a curtain beam type that produces high power at less costs is effectively used as an electron beam accelerator for emitting the electron beam. The acceleration voltage at the time of electron beam irradiation is preferably in the range of 100 through 300 kV. The absorbed dose is preferably kept in the range of 0.5 through 10 Mrad.

The irradiation time to get the required dose of actinic radiation is preferably 0.1 sec to 10 min., and is more preferably 0.1 sec to 5 min.

Ultraviolet rays are easy to use as actinic radiation, and are preferably used.

The photoreceptor of the present invention can be dried before and during irradiation with actinic radiation. Appropriate timing for drying can be selected by a combination thereof.

Appropriate drying conditions can be selected according to the type of solvent and film thickness. The drying temperature is preferably from the room temperature to 180° C., more preferably from 80° C. to 140° C. Drying time is preferably 1 min to 200 min, more preferably 5 min to 100 min.

The film thickness of the protective layer is preferably in the range of 0.2 through 10 μm, more preferably in the range of 0.5 through 6 μm.

The constitution of organic photoreceptor other than protective layer will now be detailed.

According to the present invention, photoreceptor means electro photographic photoreceptor constituted by organic compound having at least one function of electron charging or electron transporting which is essential to electro photographic photoreceptor, and includes all well known organic photoreceptor constituted by well-known organic charge generation material or organic charge transport material and photoreceptor comprising polymer complex for function of charge generation and charge transport.

Organic photoreceptor of the present invention comprises conductive substrate, provided thereon at least photosensitive layer and the protective layer is laminated in this order. Specifically, following layer structure is exemplified.

1) Layer structure comprising conductive substrate, provided thereon intermediate layer, charge generating layer and charge transport layer as photosensitive layer, and protective layer is laminated in this order.

2) Layer structure comprising conductive substrate, provided thereon intermediate layer, single layer containing charge generating material and charge transport material as photosensitive layer, and protective layer is laminated in this order.

The layer constitution of photoreceptor of the present invention related to above 1) will now be detailed.

[Conductive Support]

There is no restriction to the support used in the present invention if it is conductive. The examples are:

a drum or a sheet formed of such a metal as aluminum, copper, chromium, nickel, zinc and stainless steel;

a plastic film laminated with such a metal foil as aluminum and copper;

a plastic film provided with vapor deposition of aluminum, indium oxide, and tin oxide; and

a metal, plastic film, or paper provided with a conductive layer by coating a conductive substance independently or in combination with a binder resin.

[Intermediate Layer]

An intermediate layer having a barrier function and adhesion function can be provided between the conductive layer and a photosensitive layer in the present invention.

To form the intermediate layer, such a binder resin as casein, polyvinyl alcohol, nitrocellulose, ethylene-acrylic acid copolymer, polyamide, polyurethane or gelatin is dissolved in a solvent, and the intermediate layer can be formed by dip coating. Of these materials, alcohol soluble polyamide resin is preferably used.

In view of arranging resistivity of intermediate layer, conductive fine particles or metal oxide may be included. For example, employable is metal oxide such as alumina, zinc oxide, tin oxide, antimony oxide, indium oxide, and bismuth oxide. Further, super fine particles such as tin doped indium oxide or antimony doped tin oxide or zirconium oxide is also employable.

This metal oxide may be employed individually or in combinations of at least two types. In the case of mixing two or more types, solid solution or fusion state may be also available. Average particle diameter is preferably 0.3 μm or less, more preferably 0.1 μm or less.

The solvent used for preparation of the intermediate layer is preferably capable of effective dispersion of inorganic particles and dissolution of polyamide resin. The preferred solvent is exemplified by alcohols containing 2 through 4 carbon atoms such as ethanol, n-propyl alcohol, isopropyl alcohol, n-butanol, t-butanol, and sec-butanol having excellent polyamide resin dissolution and coating performances. Further, to improve the storage ability and particle dispersion, it is possible to use an auxiliary solvent which provides excellent effects when used in combination with the aforementioned solvent. The examples of such an auxiliary solvent are methanol, benzyl alcohol, toluene, methylene chloride, cyclohexane, and tetrahydrofuran.

The concentration of the binder resin is selected as appropriate in conformity to the film thickness of the intermediate layer and production speed.

When inorganic particles are dispersed in the binder resin, the amount of the mixed inorganic resin is preferably in the range of 20 through 400 parts by mass, more preferably in the range of 50 through 200 parts by mass, with respect to 100 parts by mass of the binder resin.

An ultrasonic homogenizer, ball mill, sand grinder, and homomixer can be used to disperse the inorganic particles.

The method of drying the intermediate layer can be selected as appropriate in conformity to the type of solvent and film thickness. The method of drying by heat is preferably used.

The film thickness of the intermediate layer is preferably 0.1 to 15 μm, more preferably 0.3 through 10 μm.

[Charge Generation Layer]

The charge generation layer is preferably a layer that contains a charge generation material and a binder resin, and is formed by dispersing the charge generation material in the binder resin solution, and coating the same.

The charge generation material is exemplified by an azo material such as Sudan Red and Diane Blue; quinone pigment such as pyrene quinone and anthanthrone; quinocyanine pigment; perylene pigment; indigo pigment such as indigo, and thioindigo; and phthalocyanine pigment. These charge generation materials can be used independently or in the form dispersed in the resin.

The conventional resin can be used as the binder resin of the charge generation layer. Such a resin is exemplified by polystyrene resin, polyethylene resin, polypropylene resin, acryl resin, methacryl resin, vinyl chloride resin, vinyl acetate resin, polyvinyl butyral resin, epoxy resin, polyurethane resin, phenol resin, polyester resin, alkyd resin, polycarbonate resin, silicone resin, melamine resin, copolymer resin containing two or more of these resins (e.g., vinyl chloride-vinyl acetate copolymer, vinyl chloride-vinyl acetate-anhydrous maleic acid copolymer), and polyvinyl carbazole resin, without being restricted thereto.

The charge generation layer is preferably formed as follows: The charge generation material is dispersed by a homogenizer into solution obtained by dissolving a binder resin in solvent, whereby a coating composition is prepared. Then the coating composition is coated to a predetermined thickness using a coating device. After that, the coated film is dried, whereby the charge generation layer is formed.

The examples of the solvent used for dissolving the binder resin used for preparing the charge generation layer and coating include toluene, xylene, methylene chloride, 1,2-dichloroethane, methyl ethyl ketone, cyclohexane, ethyl acetate, butyl acetate, methanol, ethanol, propanol, butanol, methyl cellosolve, ethyl cellosolve, tetrahydrofuran, 1-dioxane, 1,3-dioxolane, pyridine and diethyl amine, without being restricted thereto.

An ultrasonic homogenizer, ball mill, sand grinder, and homomixer can be used to disperse the charge generation material.

The amount of the charge generation material is preferably 1 through 600 parts by mass of the charge generation material, more preferably 50 through 500, with respect to 100 parts by mass of binder resin. The film thickness of the charge generation layer differs according to the characteristics of the charge generation material and binder resin and percentage of mixture, and is preferably 0.01 through 5 μm, more preferably 0.05 through 3 μm. An image defect can be prevented from occurring by filtering out the foreign substances and coagulants before applying the coating composition for the charge generation layer. It can be formed by vacuum evaporation coating of the aforementioned pigment.

[Charge Transport Layer]

The charge transport layer used in the photosensitive layer contains a charge transport material and binder resin, and is formed by dissolving the charge transport material in the binder resin and coating the same.

The charge transport material is exemplified by carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidnzolidine derivatives, styryl compound, hydrazone compound, pyrazoline compound, oxazolone derivatives, benzimidazole derivatives, quinazoline derivatives, benzofuran derivatives, acridine derivatives, phenazine derivatives, aminostilbene derivatives, triarylamine derivatives, phenylene diamine derivatives, stilbene derivatives, benzidine derivatives, poly-N-vinyl carbazole, poly-1-vinyl pyrene, and poly-9-vinyl anthracene. Two or more of these substances can be mixed for use.

As a charge transport material for charge transport layer, compound represented in Formula (4) is preferably employed.

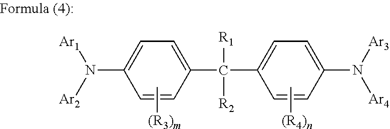

In Formula (4), R₁ and R₂ each represents alkyl group or aryl group, R₁ and R₂ may be joined to form a ring structure; R₃ and R₄ each represents hydrogen atom, alkyl group or aryl group, Ar₁ to Ar₄ each represents substituted or un-substituted aryl group and may be the same or different, Ar₁ and Ar₂, Ar₃ and Ar₄ may be joined to form a ring structure; m and n is an integer of 1 to 4.

The compounds represented by Formula (4) will now be specifically exemplified.

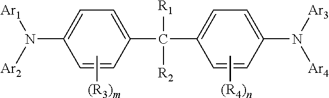

| CTM-No. | Ar₁ | | Ar₃ | Ar₂ | Ar₄ |
|---|---|---|---|---|---|
| CTM-1 | 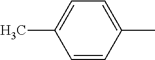 | | 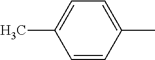 | 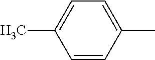 | 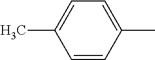 |
| CTM-2 | 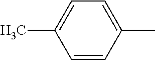 | | 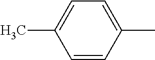 | 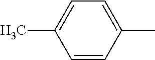 | 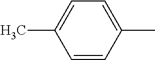 |
| CTM-3 | 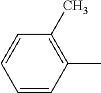 | | 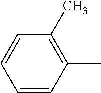 | 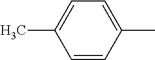 | 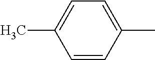 |
| CTM-4 | 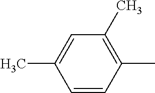 | | 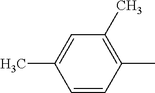 | 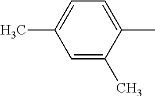 | 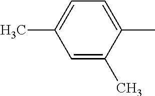 |
| CTM-5 | 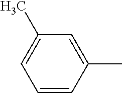 | | 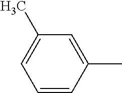 | 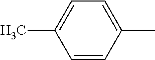 | 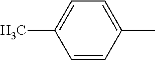 |
| CTM-6 | 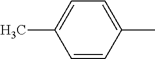 | | 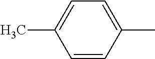 | 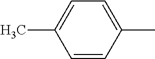 | 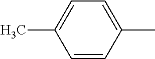 |
| CTM-7 | 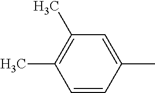 | | 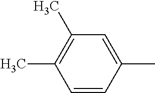 | 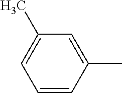 | 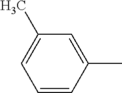 |
| CTM-8 | 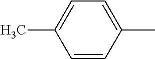 | | 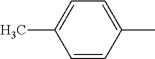 | 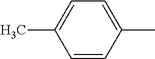 | 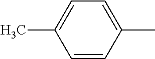 |
| CTM-9 | 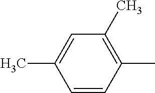 | | 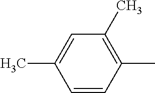 | 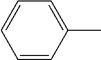 | 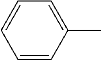 |
| CTM-10 | 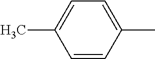 | | 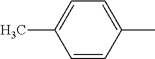 | 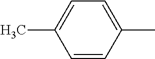 | 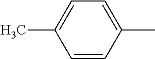 |
| CTM-11 | 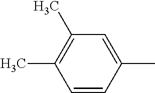 | | 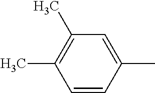 | 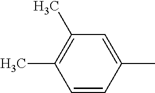 | 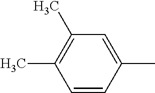 |
| CTM-12 | 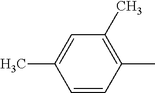 | | 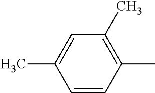 | 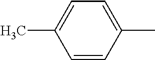 | 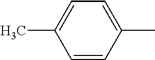 |
| CTM-13 | 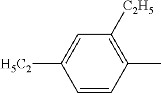 | | 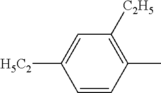 | 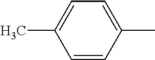 | 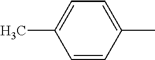 |
| CTM-14 | 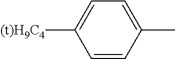 | | 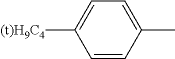 | 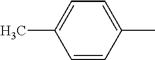 | 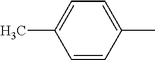 |
| CTM-15 | 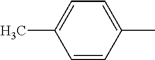 | | 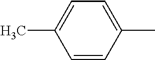 | 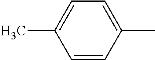 | 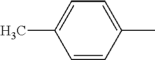 |
| | CTM-No. | R₁ | R₂ | 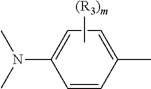 | 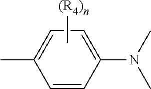 |
| | CTM-1 | —CH₃ | —CH₃ | 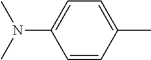 | 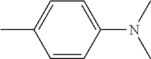 |
| | CTM-2 | —CH₃ | —C₂H₅ | 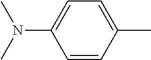 | 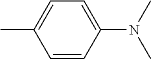 |
| | CTM-3 | —CH₃ | —C₃H₇(i) | 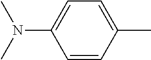 | 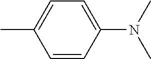 |
| | CTM-4 | —CH₃ | —C₄H₉(n) | 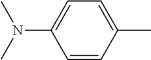 | 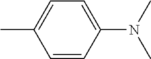 |
| | CTM-5 | —CH₃ | 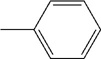 | 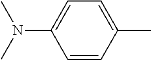 | 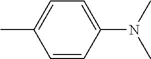 |
| | CTM-6 | 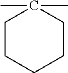 | | 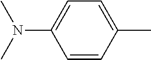 | 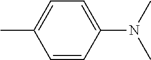 |
| | CTM-7 | —CH₃ | —CH₃ | 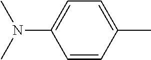 | 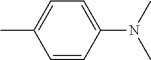 |
| | CTM-8 | —H | —H | 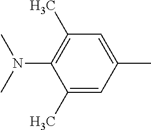 | 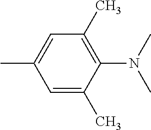 |
| | CTM-9 | —CH₃ | —CH₃ | 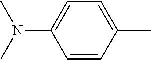 | 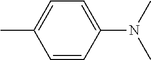 |
| | CTM-10 | 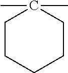 | | 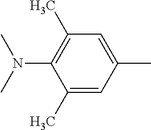 | 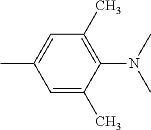 |
| | CTM-11 | 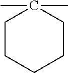 | | 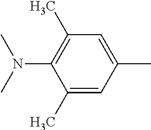 | 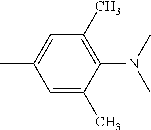 |
| | CTM-12 | 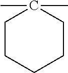 | | 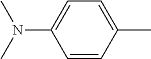 | 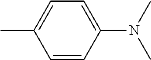 |
| | CTM-13 | 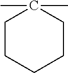 | | 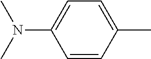 | 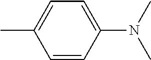 |
| | CTM-14 | 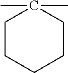 | | 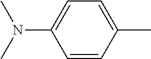 | 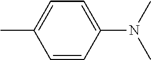 |
| | CTM-15 | —C₂H₅ | —C₂H₅ | 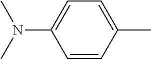 | 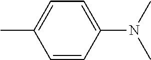 |

The conventional resin can be used as the binder resin for the charge transport layer. The examples include polycarbonate resin, polyacrylate resin, polyester resin, polystyrene resin, styrene-acrylonitrile copolymer resin, polymethacrylate ester resin, and styrene-methacrylate ester copolymer. Polycarbonate is preferably used. Further, BPA (Bisphenol A), BPZ (Bisphenol dimethyl BPA, and BPA-dimethyl BPA copolymers are preferably used because of excellent resistance to cracks and anti-abrasion, and charge characteristics.

The charge transport layer is preferably formed by dissolving binder resin and a charge transport material to prepare a coating composition, which is then applied to the layer to a predetermined thickness. Then the coating layer is dried.

The examples of the solvent for dissolving the binder resin and charge transport materials include toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethyl amine, without being restricted thereto.

The amount of charge transport material is preferably in the range of 10 through 500 parts by mass of charge transport material, more preferably in the range of 20 through 100 parts by mass, with respect to 100 parts by mass of binder resin.

The thickness of the charge transport layer varies according to the characteristics of the charge transport material and binder resin, and percentage of mixture, and is preferably 5 through 40 μm, more preferably 10 through 30 μm.

An antioxidant, electronic conductive agent, and stabilizer can be applied to the charge transport layer. The antioxidants listed in JP-A 2000-305291, and electronic conductive agents listed in JP-A S50-137543 and JP-A S58-76483 are preferably used.

[Image Forming Apparatus]

An image forming apparatus to which the organic photoreceptor may be applied is described.

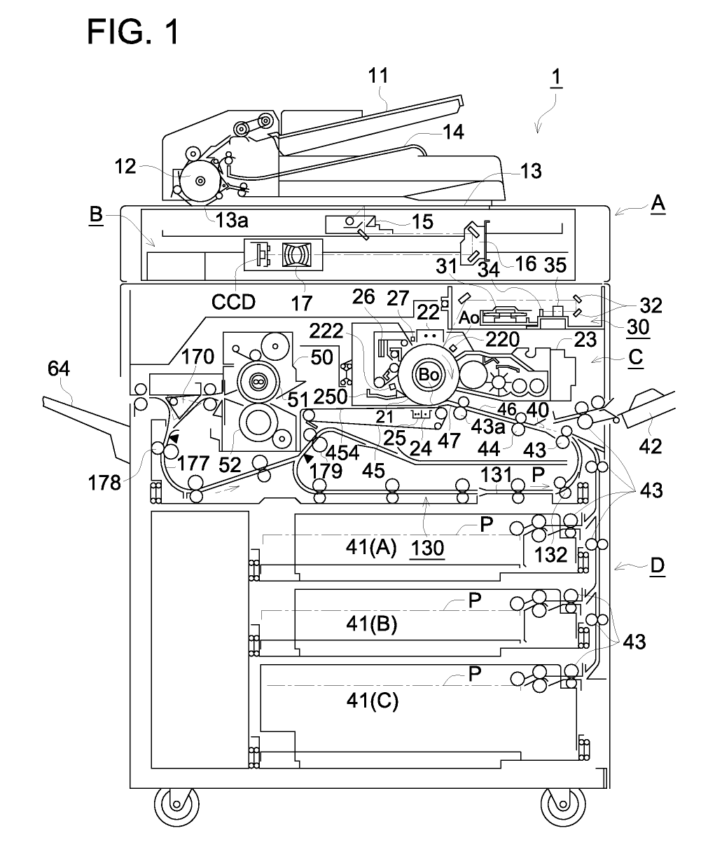

The image forming apparatus 1 shown in FIG. 1 is a digital type image forming apparatus, and is structured by an image reading section A, image processing section B, image forming section C, and transfer sheet conveyance section D.

An automatic document feeding unit to automatically convey documents is provided on the upper portion of the image reading section A, and the documents placed on a document placement board 11 are separated one by one sheet and conveyed by a document conveyance roller 12, and an image is read at a reading position 13a. The document, whose reading is completed, is delivered by the document conveyance roller 12 onto a document sheet delivery tray 14.

An image of the document when it is placed on a platen glass 13, is read out by a reading operation at a speed of v of the first mirror unit 15 which is composed of an illumination lamp and the first mirror, and by a moving exposure at a speed of v/2 of the second minor unit 16 in the same direction which is composed of the second mirror and the third mirror, which are positioned in V-letter shape, wherein the first mirror unit 15 and the second minor unit constitute a scanning optical system.

The read image is formed on the light receiving surface of an image pick-up element CCD, which is a line sensor, through a projection lens 17. A line-shaped optical image formed on the image pick-up element CCD is successively electro-optical converted into electrical signal (brightness signal), then A/D converted, and after processing such as density conversion, filter processing, or the like, is conducted in an image processing section B, the image data is temporarily stored in a memory.

In the image forming section C, as image forming units, around the outer periphery of a drum-like photoreceptor 21, a charging member (charging process) 22 to charge on the photoreceptor, a potential detecting device 220 to detect the potential on the photoreceptor, a developing unit (developing process) 23, a transfer belt 45 (transfer process), a cleaning unit 26 cleaning the photoreceptor 21 (cleaning process), and pre-charge lamp (PCL) 27 eliminating potential by light on the photoreceptor (eliminating potential by light process) are respectively arranged in the order of operation. A reflective density meter 222, which measures reflective density of developed patch image, is equipped on the photoreceptor at the down stream of the developer 23. The photoreceptor drum 21 according to this invention is rotated clockwise in the drawing.

After uniform charging by the charger 22 is conducted on the rotating the photoreceptor 21, image exposure is conducted by the exposure optical system 30 according to an image signal read from the memory of the image processing section B. The exposure optical system 30, which is a writing unit, uses a laser diode, not shown, as a light emitting source, and an optical path is changed by a reflection mirror 32 through a rotating polygonal mirror 31, fθ lens 34, and cylindrical lens 35, and the primary scanning is conducted. The image exposure is conducted at position Ao on the photoreceptor drum 21, and a latent image is formed by the rotation (the subsidiary scanning) of the photoreceptor drum 21. In the present example, exposure is conducted on a portion having characters and a reversal latent image is formed.

A semiconductor laser or an emission diode having oscillation wave length of 350-500 nm is employed for image exposure to form a latent image on the photoreceptor in this invention. An electrophotographic image having 600-2,500 dpi (dpi: number of dots per 2.54 cm) high definition can be obtained by employing these exposing light source with exposing laser light beam spot of 10-50 μm in the primary scanning direction and exposing digitally.

As above image exposing light source, a surface-emitting laser array may be employable.

The laser light beam spot is a radius of a length of exposing beam (Ld) measured at the maximum position along with a primary scanning direction in an area having exposing intensity of more than 1/e² times of peak intensity of the exposing light beam.

Image exposure is conducted by light beam employing a scanning optical system such as semiconductor laser, and a solid scanner such as LED. The light beam intensity distribution includes Gaussian, Lorentzian and so on. The area having exposing intensity of more than 1/e² times of peak intensity of the exposing light beam is the light beam spot.

The latent image on the photoreceptor drum 21 is reversal-developed by the developing unit 23, and a visual image by a toner is faulted on a surface of the photoreceptor drum 21. A polymerization toner for the developer is preferably used. An electrophotography having better sharpness can be obtained by employing the polymerization toner having uniform shape and particle size distribution in combination with the photoreceptor of the present invention.

[Polymerization Toner]

A latent image formed on the photoreceptor is visualized to a toner image via development. The toner used in the development includes pulverized toner or polymerization toner, and polymerization toner is preferable because stable particle size distribution is obtained.

In the polymerization toner, the shape of toner particles are formed by a polymerization of monomer raw material of the binder resin material and, if necessary, a chemical process thereafter. Practically, the toner is prepared by polymerization such as suspension polymerization or emulsion polymerization and a process of fusing particles after the polymerization.

Volume average particle diameter of the toner, i.e. 50% volume particle (Dv 50), is preferably 2 to 9 μm, and more preferably 3 to 7 μm. High resolution of the image is obtained by employing toner having such particle size distribution condition. Further, the toner can be composed of reduced content of minute particle size though the toner is small particle size toner, and color reproduction of dot image is improved for long time and toner image having good sharpness and stability can be obtained.

The toner of the present invention can be used in the form of a one-component developer and two-component developer.

The one-component developer to be used includes the non-magnetic one-component developer and the magnetic one-component developer formed by about 0.1 μm through 0.5 μm of magnetic particles contained in the toner. Both of them can be used.

The developer can be mixed with a carrier and can be used as a two-component developer. Examples of the carrier are conventional magnetic particles as exemplified by metals such as iron, ferrite and magnetite, and alloys between these metals and such metals as aluminum and lead. Use of the ferrite particles is preferred in particular. The particle size of the aforementioned carrier is preferably 15 to 100 μm in terms of mass-average particle size, more preferably 25 to 80 μm.

The carrier particle size can be measured typically by the laser diffraction type particle size distribution measuring instrument “HELOS” (by Sympatec Inc.).

The preferred carrier is the one whose magnetic particles are coated further with resin, or the so-called resin dispersed carrier wherein magnetic particles are dispersed in resin. There is no particular restriction to the type of the resin for coating. For example, olefin resin, styrene resin, styrene-acrylic resin, silicone resin, ester resin, or fluorine-containing polymer resin are used. Further, there is no particular restriction to the type of the resins for constituting the resin dispersed carrier. The conventionally known resins can be used. Examples are styrene-acrylic resin, polyester resin, fluorine resin, and phenol resin.

In the transfer sheet conveyance section D, sheet feed units 41(A), 41(B), and 41(C) in which different sized transfer sheet P are accommodated, are provided in the lower portion of the image forming unit, and on the side portion, a manual sheet feed unit 42 to conduct the manual sheet feed is provided, and the transfer sheet selected from any one of these sheet feed units, is fed along a sheet feed path 40 by a guiding roller 43. The transfer sheet P is temporarily stopped and then fed by the register roller 44 by which inclination and deflection of the feeding transfer sheet are corrected, and through a sheet feed path 40, a pre-transfer roller 43a, a paper providing pass 46 and an entrance guide plate 47, the toner image on the photoreceptor drum 21 is transferred onto the transfer sheet P at the transfer position Bo by the transfer electrode 24 and separation electrode 25, during conveyed via transfer conveying belt 454 of the transfer conveying unit 45. The transfer sheet P is separated from the photoreceptor drum 21 surface, and conveyed to the fixing unit 50 by the transfer conveying unit 45.

The fixing unit 50 has a fixing roller 51 and a pressure roller 52, and the transfer sheet passes between the fixing roller 51 and the pressure roller 52, thereby, toner is fused by heat and pressure. The transfer sheet P, on which the toner image has been fixed, is delivered onto the sheet delivery tray 64.

The situation for image forming on one side of the image receiving sheet is described above. When the copies are made on both sides of the sheet, the paper outputting course changing member 170 is switched so that the transfer paper guiding member 177 is opened and the transfer paper P is conveyed in the lower direction.

The transfer paper P is conveyed to the lower direction by a conveying mechanism 178 and switch-backed, so as to become the tail of the paper to top, and guided into a paper supplying unit for double-face copying 130.

The transfer paper P is conveyed to paper supplying direction on the conveying guide 131 provided in the paper supplying unit for double-face copying 130 and re-supplied by the paper supplying roller 132 and guided to the conveying course 40.

The transfer paper P is conveyed to the photoreceptor 21 and a toner image is transferred onto the back side of the transfer paper P, and output onto the paper output tray 64 after fixing the toner image by the fixing unit 50, as mentioned above.

In the image forming method according to the invention, the photoreceptor and another member such as the developing unit and the cleaning unit may be combined as a unit of a processing cartridge which can be freely installed to and released from the main body of the apparatus. Besides, at least one of the charging unit, imagewise exposing unit, developing unit, transferring or separating unit and cleaning unit may be unitized with the photoreceptor to form a processing cartridge which is able to be freely installed to or released from the main body of the apparatus using a guiding means such as a rail.

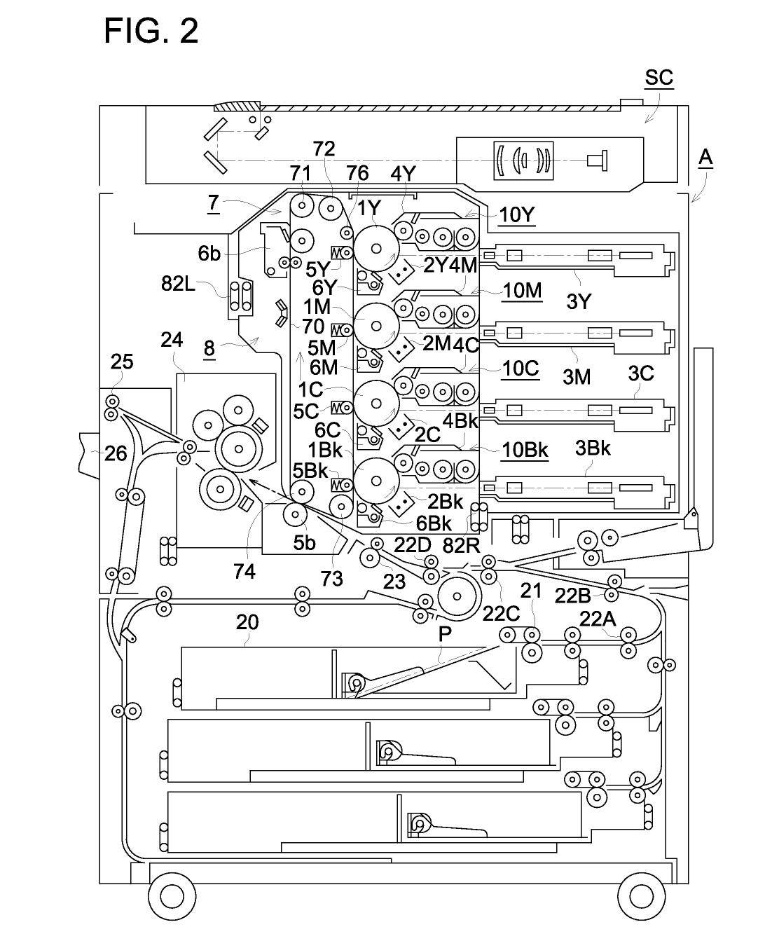

FIG. 2 is a schematic view of an example of a color image forming apparatus.

The color image forming apparatus is one so called as a tandem type color image forming apparatus, in which plural image forming units 10Y, 10M, 10C and 10Bk, an endless belt-shaped intermediate transfer unit 7, a paper conveying unit 21 and a fixing unit 24 are equipped. An original image reading unit SC is arranged at the upper portion of the main body of the image forming apparatus.

The image forming unit 10Y for forming a yellow colored image has a drum-shaped photoreceptor 1Y as a primary image carrier, and a charging unit 2Y (charging step), exposing unit 3Y (exposing step), developing unit 4Y (developing step), a primary transfer roller 5Y as a primary transfer unit (primary transferring step) and a cleaning unit 6Y which are arranged around the photoreceptor 1Y. The image forming unit 10M for forming a magenta colored image has a drum-shaped photoreceptor 1M, and a charging unit 2M, exposing unit 3M, developing unit 4M, a primary transfer roller 5M as a primary transfer unit and a cleaning unit 6M. The image forming unit 10C for forming a cyan colored image has a drum-shaped photoreceptor 1C, and a charging unit 2C, exposing unit 3C, developing unit 4C, a primary transfer roller 5C as a primary transfer unit and a cleaning unit 6C. The image forming unit 10Bk for forming a black colored image has a drum-shaped photoreceptor 1Bk, and a charging unit 2Bk, exposing unit 3Bk, developing unit 4Bk, a primary transfer roller 5Bk as a primary transfer unit and a cleaning unit 6Bk.

The four image forming units 10Y, 10M, 10C and 10Bk are composed of rotating charge unit 2Y, 2M, 2C and 2Bk, image exposing unit 3Y, 3M, 23C and 3Bk, rotating developing unit 4Y, 4M, 4C and 4Bk, and cleaning unit 5Y, 5M, 5C and 5Bk, each cleaning the photoreceptor drums 1Y, 1M, 1C and 1Bk, around the photoreceptor drums 1Y, 1M, 1C and 1Bk.

The image forming units 10Y, 10M, 10C and 10Bk are similar except that the color of toner image formed on the photoreceptors 1Y, 1M, 1C and 1BK are different, and therefore, the description is detailed representatively taking the image forming unit 10Y.

The image forming units 10Y is composed of charging unit 2Y (hereinafter, simply referred to as charging unit 2Y or charger 2Y), exposing unit 3Y, developing unit 4Y and cleaning unit 5Y (hereinafter, simply referred to as cleaning unit 5Y or cleaning blade 5Y) arranged around a photoreceptor drum 1Y, to form yellow (Y) toner image on the photoreceptor drum 1Y. At least the photoreceptor drum 1Y, charging unit 2Y, developing unit 4Y and cleaning unit 5Y are provided integrally among the image forming unit 10Y in one of the embodiment of this invention.

The charging unit 2Y gives uniform potential to the photoreceptor drum 1Y, and a corona discharge type charger 2Y is provided for the photoreceptor drum 1Y.

The image exposure unit 3Y exposes light according to yellow image signal to the photoreceptor 1Y, on which uniform potential has been given by charger 2Y, so as to form a latent image corresponding to the yellow (Y) image. A semiconductor laser or an emission diode having oscillation wave length of 350-500 nm is employed for image exposure to form a latent image on the photoreceptor in this invention. An electrophotographic image having 600-2,500 dpi (dpi: number of dots per 2.54 cm) high definition can be obtained by employing these exposing light source with exposing laser light beam spot of 10-50 μm in the primary scanning direction and exposing digitally. Further, a surface-emitting laser array described above may be employable. The exposure unit which comprises LED array emission elements and image forming elements (product name: SELFOC lens), arranged around the axis of the photoreceptor drum 1Y may be employable.

The present image forming apparatus is constituted in such a manner that components such as the photoreceptor, development unit, cleaning unit the like are integrated as a process cartridge (image forming unit), and this unit may be detachable from the main frame. Further, the process cartridge (image forming unit) may be formed as a single detachable unit in such a manner that at least one of a charging unit, an image exposure unit, a development unit, a transfer or separation unit, and a cleaning unit is integrated with a photoreceptor, and it may be arranged to be detachable employing an guiding means such as a rail in the apparatus main frame.

The endless belt-shaped intermediate transfer unit 7 has a semiconductive endless belt-shaped transfer member 70 as a secondary image carrier which is wound on plural rollers and circulatably held.

Color images formed in the image forming units 10Y, 10M, 10C and 10Bk, respectively, are successively transferred onto the circulating endless belt-shaped intermediate transfer member 70 by the primary transfer rollers 5Y, 5M, 5C and 5Bk as the primary transfer unit, thus a color image is synthesized. The transfer paper P as a recording material (a support carrying the finally fixed image such as a plain paper sheet and a transparent sheet) stocked in a paper supplying cassette 20 is supplied by a paper supplying unit 21, and conveyed to a secondary transfer roller 5A as a secondary transferring means through intermediate conveying rollers 22A, 22B, 22C and 22D and a register roller 23. Then the color image is collectively transferred by the secondary transferring onto the transfer paper P. The color image transferred on the paper P is fixed by the fixing unit 24 and conveyed by an output roller 25 to be stood on an output tray 26. Herein, the transfer support of the toner image formed on photoreceptor such as the intermediate transfer member or the transfer paper collectively means a transfer medium.

Besides, the toner remained on the endless belt intermediate transfer member 70 is removed by the cleaning unit 6b after the color image is transferred to the paper P by the secondary transfer roller 5b and the paper P is separated by curvature from the intermediate transfer belt.

In the course of the image formation process, the primary transfer roller 5Bk is always pressed to the photoreceptor 1Bk. The other primary transfer rollers 5Y, 5M and 5C are each contacted by pressing to the corresponding photoreceptors 1Y, 1M and 1C, respectively, only for the period of image formation.

The secondary transfer roller 5b is contacted by pressing to the endless belt-shaped intermediate transfer member 70 only for the period of the secondary transferring while passing of the paper P.

A frame 8 can be pulled out from the main body A of the apparatus through supporting rails 82L and 82R.

The frame 8 comprises the image forming units 10Y, 10M, 10C and 10Bk, and an intermediate transfer unit 7 comprising the endless belt-shaped intermediate transfer member.

The image forming units 10Y, 10M, 10C and 10Bk are serially arranged in the perpendicular direction. In the drawing, the endless belt-shaped intermediate transfer unit 7 is arranged at left side of the photoreceptors 1Y, 1M, 1C and 1Bk. The endless belt-shaped intermediate transfer unit 7 included the circulatable endless belt-shaped intermediate transfer member 70 wound with the rollers 71, 72, 73 and 74, the primary transfer rollers 5Y, 5M, 5C and 5Bk, and the cleaning unit 6b.

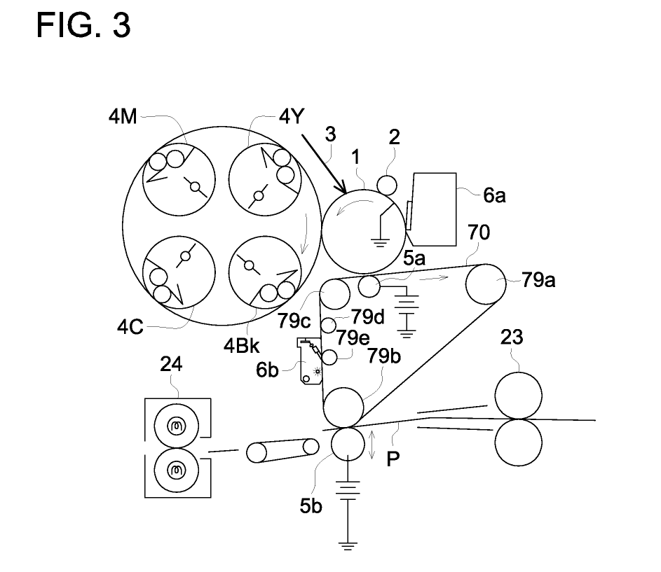

Next, FIG. 3 is a cross-sectional constitution view of a color image forming apparatus (a copier or a laser beam printer having at least a charging member, an exposure member, a plurality of developing members, a transfer member, a cleaning member, and an intermediate transfer body around an organic photoreceptor) employing the organic photoreceptor of the present invention. An elastic material of a medium resistance is used for belt-shaped intermediate transfer body 70.

Numeral 1 is a rotatable drum-type photoreceptor which is repeatedly used as an image forming body and rotationally driven at a specified peripheral rate in the counter-clockwise direction as shown by the arrow.

Photoreceptor 1 is uniformly charged during rotation at a specified polarity and potential by charging member (charging process) 2, and then is subjected to image exposure by image exposure member (image exposure process) 3 (not shown) via scanning exposure light using laser beams modulated in response to chronological electric digital pixel signals of image information to form an electrostatic latent image corresponding to a color component image (color information) of yellow (Y) of the targeted color image.

Subsequently, the resulting electrostatic latent image is developed by yellow (Y) developing member, that is, developing process (yellow developing unit) 4Y using a yellow toner which is used for a first color image. During the above operation, each of second-fourth developing members (the magenta developing unit, the cyan developing unit, and the black developing unit) 4M, 4C, and 4Bk is not operated and produces no action on photoreceptor 1, whereby the yellow toner image as the first color image is not affected by the second-fourth developing units.

Intermediate transfer body 70 is stretched around rollers 79a, 79b, 79c, 79d, and 79e, and rotationally driven in the clockwise direction at the same peripheral rate as photoreceptor 1.

While the yellow toner image as the first color, having been formed and carried on photoreceptor 1, passes the nip portion of photoreceptor 1 and intermediate transfer body 70, the image is successively subjected to intermediate transfer (primary transfer) onto the outer circumference surface of intermediate transfer body 70 via an electric field formed by a primary transfer bias applied to intermediate transfer body 70 from primary transfer roller 5a.

The surface of photoreceptor 1, having completed the transfer of the yellow toner image as the first color corresponding to intermediate transfer body 70, is cleaned by cleaning unit 6a.

Thereafter, in the same manner as above, a magenta toner image as a second color, a cyan toner image as a third color, and a black toner image as a fourth color are successively transferred onto intermediate transfer body 70 in a superposed manner to form a superposed color toner image corresponding to the targeted color image.

Secondary transfer roller 5b is subjected to bearing in parallel to secondary transfer facing roller 79b and is arranged in the bottom surface part of intermediate transfer body 70 so as to be withdrawn.

A primary transfer bias to carry out successive superposing transfer of toner images of the first-fourth colors onto intermediate transfer body 70 from photoreceptor 1 exhibits polarity opposite to that of the toner and is applied from a bias power source. The applied voltage is, for example, in the range of +100 V to +2 kV.

During the primary transfer process of toner images of the first-third colors from photoreceptor 1 to intermediate transfer body 70, secondary transfer roller 5b and intermediate transfer body cleaning member 6b may be withdrawn from intermediate transfer body 70.

Transfer of the superposed color toner image, having been transferred onto belt-shaped intermediate transfer body 70, onto transfer paper P as a second image carrier is carried out in such a manner that secondary transfer roller 5b is brought into pressure contact with the belt of intermediate transfer body 70 and transfer paper P is fed at specified timing to the contact nip between the belt of intermediate transfer body 70 and secondary transfer roller 5b through a transfer paper guide from paired paper feeding registration rollers 23. A secondary transfer bias is applied to secondary transfer roller 5b from a bias power source. The superposed color toner image is transferred (secondary transfer) by this secondary transfer bias onto transfer paper P, which is a second image carver, from intermediate transfer body 70. Transfer paper P, which has been subjected to the transfer of the toner image, is conveyed to fixing member 24 for thermal fixing.

The image forming apparatus of the present invention is applied to common electrophotographic apparatuses such as electrophotographic copiers, laser printers, LED printers, or liquid crystal shutter-type printers. In addition, it is possible to find wide applications in display, recording, short-run printing, plate making, and apparatuses such as facsimile machines to which electrophotographic technology is applied.

### Examples

The invention is illustrated by means of Examples by no means limit the scope of the present invention. The term “parts” means parts by mass.

Preparation of Photoreceptor 1

The photoreceptor 1 was produced as follows.

<Electroconductive Support>

The cylinder type aluminum support having machine surface was prepared, which surface has surface roughness Rz of 1.5 μm.

<Intermediate Layer>

Coating composition for intermediate layer formulated as below was prepared.

| | | |
|---|---|---|
| Polyamide resin X1010, manufactured by Daicel-Degussa Ltd | 1 | part |
| Tin oxide SMT500SAS, manufactured by TAYCA | 1.1 | parts |
| CORPORATION | | |
| Ethanol | 20 | parts |

The composition was dispersed in batch process for ten hours employing a sand mill dispersion apparatus.

The coating composition was applied on to the support by dipping so as to obtain an intermediate layer having thickness of 2 μm after drying 20 minutes at 110° C.

<Charge Generation Layer>

| | | |
|---|---|---|
| Charge generation material, titanyl phthalocyanine pigment, | 20 | part |
| having a maximum peak at 27.3° based on a Cu—Kα | | |
| characteristic X-ray diffraction spectrum measurement | | |
| Polyvinylbutyral resin (#6000-C, manufactured by | 10 | parts |
| Denkikagaku Kogyo Kabushiki Kaisha) | | |
| t-Butyl acetate | 700 | parts |

### 4-Methoxy-4-methyl-2-pentanone 300 Parts

The above components were mixed and dispersed by a sand mill for ten hours to prepare a coating composition for charge generation layer. The coating composition was coated on the intermediate layer by dipping method to form a charge generation layer having dry thickness of 0.3 μm.

<Charge Transport Layer>

| | | |
|---|---|---|
| Charge transport material: CTM (CTM-6) | 150 | parts |
| Binder, Polycarbonate (Z300: manufactured by Mitsubishi | 300 | parts |
| Gas Chemical Company, Inc.) | | |
| Anti-oxidant (Irganox1010, manufactured by Ciba Japan) | 6 | parts |
| Toluene/Tetrahydrofuran ( 1/9 by volume) | 2,000 | parts |
| Silicone oil (KF-96: manufactured by Shin-Etsu Chemical | 1 | part |
| Co., Ltd.) | | |

The above listed compositions were mixed and dissolved to prepare a coating composition for charge transport layer that was coated on the charge generation layer by dipping method and dried at 110° C. for 60 minutes to form a charge transport layer having dry thickness of 20 μm.

| | |
|---|---|
| Chain Polymerizable compound having a charge transport- | 100 parts |
| able structure (exemplified compound: RCTM-5) | |
| Chain Polymerizable compound without a charge transport- | 100 parts |
| able structure (exemplified compound: No. 31) | |
| Inorganic fine particles: Titan oxide (surface treated | 30 parts |
| with the same parts of methylhydrogen polysiloxane having | |
| number average primary particle size of 30 nm) | |
| Isopropyl alcohol | 500 parts |

After the above components were mixed and dispersed by a sand mill for ten hours, the following composition was mixed and dissolved under light shielding to prepare a coating composition for protective layer.

| | |
|---|---|
| Polymerization initiator 1-6 | 30 parts |

Light was shielded during storage. This coating composition was coated on photoreceptor having the charge transport layer via circular slide hopper coating machine. After dried at room temperature for 20 minutes (solvent drying process), and irradiated 1 minute by metal halide lamp (500 W) at the position of 100 mm apart while rotating the photoreceptor (ultraviolet ray curing process), protective layer having thickness of 3 μm was formed.

Preparation of Photoreceptors 2-28

Photoreceptors 2-28 were prepared in the same manner as the preparation of photoreceptor 1, except for changing material utilized in protective layer and curing condition as listed in Table 1.

Curing condition (Photo): protective layer having thickness of 3 μm was formed by irradiating 1 minute by metal halide lamp (500 W) at the position of 100 mm apart while rotating the photoreceptor.

Curing condition (Heat): protective layer having thickness of 3 μm was formed by heating 30 minutes at 140° C.

Preparation of Photoreceptors 29 (No Chain Polymerizable Compound Having a Charge Transportable Structure)

Photoreceptor 29 was prepared in the same manner as the preparation of photoreceptor 1, except for eliminating the chain polymerizable compound having a charge transportable structure (RCTM-5) from protective layer.

Preparation of Photoreceptors 30 (No Chain Polymerizable Compound without Having a Charge Transportable Structure)

Photoreceptor 30 was prepared in the same manner as the preparation of photoreceptor 1, except for eliminating the chain polymerizable compound without having a charge transportable structure (exemplified compound 31) from protective layer.

TABLE 1

| | Protective layer | | | | | | | | |
|---|---|---|---|---|---|---|---|---|---|
| | Chain Polymerizable compound | | | | | | | | |
| | | | | | | | Polymerization | | |
| Photo- | With charge transportable structure | | Without charge transportable structure | | | Inorganic | initiator | | |
| receptor | Exemplified | | Exemplified | | number of | fine | Exemplified | | Cure |
| No. | compound | Parts | compound | Parts | functional group | particles | compound | Parts | condition |
| 1 | RCTM-2 | 100 | 31 | 100 | 4 | I.F.P.-1 | 1-6 | 30 | Photo |
| 2 | RCTM-3 | 100 | 31 | 100 | 4 | I.F.P.-2 | 1-6 | 30 | Photo |
| 3 | RCTM-32 | 100 | 7 | 100 | 6 | I.F.P.-3 | 1-6 | 30 | Photo |
| 4 | RCTM-25 | 100 | 7 | 100 | 6 | I.F.P.-1 | 1-6 | 30 | Photo |
| 5 | RCTM-8 | 100 | 42 | 100 | 3 | I.F.P.-1 | 1-6 | 30 | Photo |
| 6 | RCTM-12 | 100 | 44 | 100 | 3 | I.F.P.-1 | 1-6 | 30 | Photo |
| 7 | RCTM-16 | 100 | 31 | 100 | 4 | I.F.P.-1 | 5-1 | 30 | Heat |
| 8 | RCTM-32 | 120 | 43 | 100 | 6 | I.F.P.-1 | 5-1 | 30 | Heat |
| 9 | RCTM-32 | 120 | 42 | 100 | 3 | I.F.P.-1 | 1-6 | 30 | Photo |
| 10 | RCTM-25 | 100 | 42 | 100 | 3 | I.F.P.-1 | 1-6 | 30 | Photo |
| 11 | RCTM-11 | 80 | 42 | 100 | 3 | I.F.P.-1 | 1-6 | 30 | Photo |
| 12 | RCTM-12 | 100 | 31 | 100 | 4 | I.F.P.-1 | 1-6 | 30 | Photo |
| 13 | RCTM-33 | 100 | 7 | 100 | 6 | I.F.P.-1 | 1-6 | 30 | Photo |
| 14 | RCTM-23 | 100 | 9 | 100 | 3 | I.F.P.-1 | 1-6 | 30 | Photo |
| 15 | RCTM-2 | 100 | 5 | 100 | 3 | I.F.P.-1 | 1-6 | 30 | Photo |
| 16 | RCTM-3 | 150 | 5 | 100 | 3 | I.F.P.-1 | 1-6 | 30 | Photo |
| 17 | RCTM-32 | 150 | 5 | 100 | 3 | I.F.P.-1 | 1-6 | 30 | Photo |
| 18 | RCTM-25 | 150 | 5 | 100 | 3 | I.F.P.-1 | 1-6 | 30 | Photo |
| 19 | RCTM-8 | 150 | 5 | 100 | 3 | I.F.P.-1 | 1-6 | 30 | Photo |
| 20 | RCTM-12 | 100 | 5 | 100 | 3 | I.F.P.-1 | 1-6 | 30 | Photo |
| 21 | RCTM-16 | 100 | 5 | 100 | 3 | I.F.P.-1 | 1-6 | 30 | Photo |
| 22 | RCTM-1 | 200 | 16 | 100 | 4 | — | 1-6 | 30 | Photo |
| 23 | RCTM-3 | 200 | 16 | 100 | 4 | — | 1-6 | 30 | Photo |
| 24 | RCTM-32 | 100 | 16 | 100 | 4 | — | 1-6 | 30 | Photo |
| 25 | RCTM-33 | 100 | 16 | 100 | 4 | — | 1-6 | 30 | Photo |
| 26 | RCTM-8 | 100 | 16 | 100 | 4 | — | 6-5 | 30 | Heat |
| 27 | RCTM-12 | 100 | 16 | 100 | 4 | — | 6-6 | 30 | Photo |
| 28 | RCTM-16 | 100 | 16 | 100 | 4 | — | 1-6 | 30 | Photo |
| 29 | — | — | 31 | 100 | 4 | I.F.P.-1 | 1-6 | 30 | Photo |
| 30 | RCTM-2 | 100 | — | — | — | I.F.P.-1 | 1-6 | 30 | Photo |

I.F.P.: Inorganic fine particles

In Table 1, inorganic fine particles 1 represent titan oxide surface treated with the same parts of methylhydrogen polysiloxane having number average primary particle size of 30 nm, inorganic fine particles 2 represent alumina surface treated with the same parts of methylhydrogen polysiloxane having number average primary particle size of 30 nm, and inorganic fine particles 3 represent zinc oxide surface treated with the same parts of methylhydrogen polysiloxane having number average primary particle size of 50 nm.

[Evaluation of Photoreceptor]

Photoreceptor was evaluated by mounting on commercially available full color multi function peripheral bizhub PRO C650 basically having the constitution as FIG. 2 (produced by Konica Minolta Business Technologies, Inc., 800 dpi, incorporating semiconductor laser exposure of 405 nm). Herein, evaluation was carried out under the condition that the photoreceptor in each image forming unit is unified to one kind of photoreceptor (for example, in case of photoreceptor 1, using 4 photoreceptors by photoreceptor 1), because above full color multi function peripheral has four units of image forming unit. After printing 500 thousand papers of A4 image with Y, M, C, Bk color each at 2.5% of printing area ratio on neutralized paper under ambient condition 30° C., 80% R.H., each evaluation was carried out under the individual ambient conditions.

(Fog (Evaluated by Black- and White Image))

Evaluation was carried out after printing 500 thousand papers under above ambient condition 30° C., 80% R.H. Fog density of solid white image was measured by reflection density by Macbeth densitometer RD-918. The reflection density was evaluated by relative reflection density based on reflection density of unprinted A4 paper being 0.000.

A: Density is less than 0.010 (Good)

B: Density is 0.010 or more to 0.020 or less (Practically non-problematic)

C: Density is 0.020 or more (Practically problematic)

(Blur of Image)

Main power supply of the printer was cut off immediately after finishing printing 500 thousand papers under ambient condition 30° C., 80% R.H. Power was turned on again after standing 12 hours. Just after reaching to printable mode, a halftone image (with 0.4 of relative reflection density by Macbeth densitometer) and 6 dots grid image each were printed on whole of A3 neutralized paper. State of the printed images were observed and ranked according to bellows:

A: No blur is noted on both halftone and grid image. (Good)

B: Slight band density decrease in long direction of photoreceptor is noted only on halftone image. (Practically non-problematic)

C: Defect or thinner line is clearly observed on grid image by blurred image. (Practically problematic)

(Dot Reproducibility)

Evaluation of dot reproducibility was performed by using full color multifunction peripheral bizhub PRO C6500 modified machine in such a manner that a semiconductor laser of 405 nm was used as an image exposure light source; exposure of a beam diameter of 30 μm was carried out at 1200 dpi. Evaluation items and criteria are shown below.

Evaluation of 2 Dot Line

A white line of 2 dot line was formed in a solid black image to carry out evaluation based on the following criteria.

A: A white line of 2 dot line is continuously reproduced and the image density of solid black is at least 1.2 (Good).

B: A white line of 2 dot line is continuously reproduced but the image density of solid black is 1.0—less than 1.2 (practically unproblematic).

C: A white line of 2 dot line is discontinuously reproduced; or a white line of 2 dot line is continuously reproduced but the image density of solid black is less than 1.0 (practically problematic)

The image densities described above were determined using RD-918 (produced by Macbeth Co.) as relative reflection densities, provided that the reflection density of paper was designated as “0.” The results are shown in Table 1.

(Evaluation of Color Image)

After finishing printing 500 thousand papers under ambient condition 30° C., 80% R.H., followed by standing 1 hour under ambience of 20° C., 50% R.H. A halftone image including head shot was printed on A4 paper by applying four image forming units of full color multifunction peripheral bizhub PRO C6500. State of the printed images were observed and ranked according to bellows:

A: A halftone color image is reproduced smoothly and no blur or uneven density is noted (Good)

B: Slight blur or uneven density is noted partially in a halftone color image, but it is not easy to notice and a halftone color image is reproduced smoothly (practically unproblematic).

C: Blur or uneven density is clearly observed in a halftone color image (practically problematic).

(Surface Abrasion Lines)

Evaluation of abrasion lines was carried out before and after printing 500 thousand papers under ambient condition 30° C., 80% R.H. by observation of a surface state of photoreceptor. Herein a photoreceptor for cyan image was used for evaluation.

A: After printing 500 thousand papers, no abrasion line is noted on the photoreceptor. (Good)

B: After printing 500 thousand papers, 1-5 abrasion line is noted on the photoreceptor. (Practically non-problematic)

C: After printing 500 thousand papers, abrasion line is clearly observed on the photoreceptor. (Practically problematic)

(Wear Amount of Photoreceptor)

Wear amount of photoreceptor was calculated by measuring a layer thickness of photoreceptor at initial and after printing 500 thousand papers under ambient condition 30° C., 80% R.H. according to above evaluation. Ten points of layer thickness were measured in random at uniform thickness portion of photoreceptor and an average was defined as the layer thickness of photoreceptor. At least 3 cm from both edge of photoreceptor were excluded from evaluation, because layer thickness tends to be uneven at edge of photoreceptor. Eddy current type thickness meter EDDY 560C (produced by HELMUT FISHER GMBTE Co.) was used as a layer thickness measuring instrument and the difference between layer thickness of photoreceptor before and after printing was defined as wear amount of photoreceptor.

A: Wear amount of photoreceptor is 0.7 μm or less. (Good)

B: Wear amount of photoreceptor is 0.8 μm to 2 μm. (Practically non-problematic)

C: Wear amount of photoreceptor is 2 μm or more. (Practically problematic)

Evaluation Results are Listed in Table 2.

TABLE 2

| | Evaluation | | | | | | |
|---|---|---|---|---|---|---|---|
| Photo- | | | Dot | | | | |
| receptor | | | reproduc- | Color | Surface | Wear | Re- |
| No. | Fog | Blur | ibility | image | scratch | amount | marks |
| 1 | A | A | A | B | A | A | Inv. |
| 2 | A | A | A | B | A | A | Inv. |
| 3 | A | A | A | A | A | A | Inv. |
| 4 | A | A | A | A | A | A | Inv. |
| 5 | A | A | B | A | A | A | Inv. |
| 6 | A | A | B | A | A | A | Inv. |
| 7 | A | A | A | A | A | B | Inv. |
| 8 | A | A | A | A | A | B | Inv. |
| 9 | A | A | A | A | A | A | Inv. |
| 10 | A | A | A | A | A | A | Inv. |
| 11 | A | B | B | A | A | A | Inv. |
| 12 | A | A | B | A | A | A | Inv. |
| 13 | A | A | A | A | A | A | Inv, |
| 14 | A | A | A | A | A | A | Inv. |
| 15 | A | B | A | A | A | A | Inv. |
| 16 | A | B | A | A | A | A | Inv. |
| 17 | A | A | A | A | A | A | Inv. |
| 18 | A | A | A | A | A | A | Inv. |
| 19 | A | A | B | A | A | A | Inv. |
| 20 | A | B | A | A | A | A | Inv. |
| 21 | A | A | A | A | A | A | Inv. |
| 22 | A | B | A | A | A | B | Inv. |
| 23 | A | B | A | A | A | B | Inv, |
| 24 | A | A | A | A | A | B | Inv. |
| 25 | A | A | A | A | A | B | Inv. |
| 26 | A | B | A | B | A | B | Inv, |
| 27 | A | B | A | B | A | B | Inv. |
| 28 | A | A | A | A | A | B | Inv. |
| 29 | C | C | C | B | B | A | Comp. |
| 30 | B | C | C | C | C | B | Comp. |

Inv.: Inventive example, Comp.: Comparative example

As can be clearly seen from the results described in Table 2, it is found that the photoreceptors 1-28 in the present invention exhibit more than practical in each evaluation item, while the comparative examples 29 and 30 exhibits practically problematic in either evaluation item.

### DESCRIPTION OF THE ALPHANUMERIC DESIGNATIONS

10Y, 10M, 10C, and 10Bk: image forming units
1Y, 1M, 1C, and 1Bk: photoreceptors
2Y, 2M, 2C, and 2Bk: charging members
3Y, 3M, 3C, and 3Bk: exposure members
4Y, 4M, 4C, and 4Bk: developing members

What is claimed is:

1. An organic photoreceptor having a conductive substrate, provided thereon at least a photo sensitive layer and a protective layer in this order, wherein
the protective layer comprises a resin layer obtained by a reaction between a chain polymerizable compound having a charge transportable structure represented by Formula (1) and a chain polymerizable compound without having a charge transportable structure, 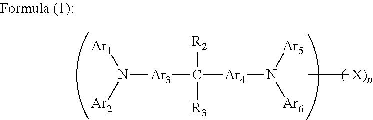
wherein R₂ and R₃ each represents alkyl group or aryl group, R₂ and R₃ may be joined to form a ring structure; Ar₃ and Ar₄ each represents substituted or un-substituted arylene group; Ar₁, Ar₂, Ar₅ and Ar₆ each represents substituted or un-substituted aryl group; n is an integer of 1 to 4 and represents a number of a substituted hydrogen atom in Ar₁, Ar₂, Ar₅ and Ar₆ by X, wherein X is a group represented by Formula (2), 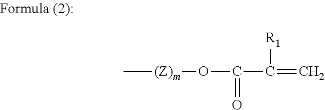
wherein R₁ represents hydrogen atom, halogen atom, substituted or un-substituted alkyl group, substituted or un-substituted aralkyl group, substituted or un-substituted aryl group, cyano group, nitro group, alkoxy group, —COOR₄ (R₄ represents hydrogen atom, substituted or un-substituted alkyl group, substituted or un-substituted aralkyl group, or substituted or un-substituted aryl group), halogenated carbonyl group or CONR₅R₆ (R₅ and R₆ each represents hydrogen atom, halogen atom, substituted or un-substituted alkyl group, substituted or un-substituted aralkyl group, or substituted or un-substituted aryl group and may be the same or different), Z represents substituted or un-substituted alkylene group, substituted or un-substituted alkylene ether divalent group, alkylene oxy carbonyl divalent group; and m is an integer of 0 to 3.

2. The organic photoreceptor of claim 1, wherein
the chain polymerizable compound having a charge transportable structure represented by Formula (1) is represented by Formula (3), 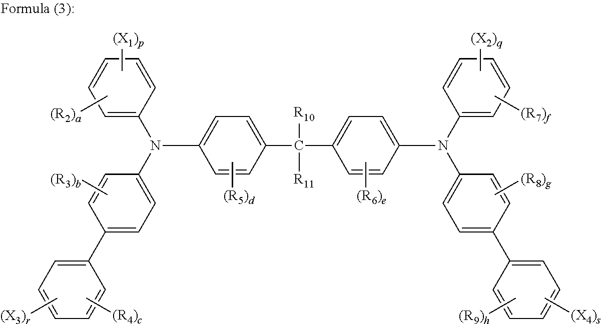
wherein R₂ to R₉ each represents alkyl group or alkoxy group having 1 to 5 carbon numbers; a to h represents an integer of 0 to 5; R₁₀ and R₁₁ each represents alkyl group or aryl group and R₁₀ and R₁₁ may be joined to form a ring structure; X₁, X₂, X₃ and X₄ each represents Formula (2); p, q, r and s each represents an integer of 0 or 1 respectively and at least one of p, q, r and s represents an integer of 1.

3. The organic photoreceptor of claim 1, wherein R₁ in Formula (2) is hydrogen atom, substituted or un-substituted alkyl group.

4. The organic photoreceptor of claim 1, wherein a number of the chain polymerizable functional group in the chain polymerizable compound without having the charge transportable structure is 3 or more.

5. The organic photoreceptor of claim 1, wherein the protective layer comprises metal oxide particles.

6. An image forming apparatus to repeatedly conduct image formation, comprising an organic photoreceptor and provided thereabout, at least a charging member, an exposing member, and a developing member, wherein the organic photoreceptor is the organic photoreceptor of claim 1.

7. A process cartridge utilized in the image forming apparatus of claim 6, comprising at least one of the organic photoreceptor of claim 1, the charging member, the exposing member and the developing member integrated as a unit which can be adopted to be installed to or released from the image forming apparatus.

8. A method for producing an organic photoreceptor having a conductive substrate, provided thereon at least a photo sensitive layer and a protective layer in this order, so as to form the protective layer, comprising a step of reacting a chain polymerizable compound having a charge transportable structure represented by Formula (1) with a chain polymerizable compound without having a charge transportable structure, 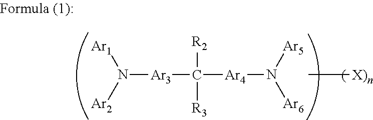
wherein R₂ and R₃ each represents alkyl group or aryl group, R₂ and R₃ may be joined to form a ring structure; Ar₃ and Ar₄ each represents substituted or un-substituted arylene group; Ar₁, Ar₂, Ar₅ and Ar₆ each represents substituted or un-substituted aryl group; n is an integer of 1 to 4 and represents a number of a substituted hydrogen atom in Ar₁, Ar₂, Ar₅ and Ar₆ by X, wherein X is a group represented by Formula (2), 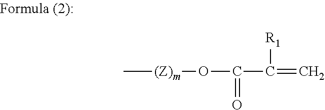
wherein R₁ represents hydrogen atom, halogen atom, substituted or un-substituted alkyl group, substituted or un-substituted aralkyl group, substituted or un-substituted aryl group, cyano group, nitro group, alkoxy group, —COOR₄ (R₄ represents hydrogen atom, substituted or un-substituted alkyl group, substituted or un-substituted aralkyl group, or substituted or un-substituted aryl group), halogenated carbonyl group or CONR₅R₆ (R₅ and R₆ each represents hydrogen atom, halogen atom, substituted or un-substituted alkyl group, substituted or un-substituted aralkyl group, or substituted or un-substituted aryl group and may be the same or different), Z represents substituted or un-substituted alkylene group, substituted or un-substituted alkylene ether divalent group, alkylene oxy carbonyl divalent group; and m is an integer of 0 to 3.
